(19) United States
(12) Patent Application Publication
(10) Pub. No.: US 2024/0426523 A1
(43) Pub. Date: Dec. 26, 2024

(54) REFRIGERATION CYCLE DEVICE

(71) Applicant: DENSO CORPORATION, Kariya-city (JP)

(72) Inventors: Junki HIRAYAMA, Kariya-city (JP); Toru OKAMURA, Kariya-city (JP); Naoya MAKIMOTO, Kariya-city (JP); Hiroaki KAWANO, Kariya-city (JP); Naito MUTO, Kariya-city (JP); Yoshiki KATO, Kariya-city (JP)

(21) Appl. No.: 18/824,748

(22) Filed: Sep. 4, 2024

Related U.S. Application Data
(63) Continuation of application No. PCT/JP2023/010119, filed on Mar. 15, 2023.

(30) Foreign Application Priority Data
Mar. 21, 2022 (JP) 2022-044794

(51) Int. Cl. F25B 1/10; F25B 5/02

(52) U.S. Cl. CPC F25B 1/10; F25B 5/02; F25B 2700/00

(57) ABSTRACT

A refrigeration cycle device includes a compressor, a radiator, a first decompression unit, a first evaporator, a second decompression unit, and a second evaporator. A refrigerant joining portion joins refrigerant having passed through the first evaporator and the second evaporator, on a refrigerant suction side of the compressor. The first decompression unit regulates a degree of superheating of the refrigerant between the first evaporator and the refrigerant joining portion on the basis of a first physical quantity having a correlation with the degree of superheating of the refrigerant flowing between the first evaporator and the refrigerant joining portion. The second decompression unit regulates a degree of superheating of the refrigerant between the refrigerant joining portion and the compressor on the basis of a second physical quantity having a correlation with the degree of superheating of the refrigerant flowing between the refrigerant joining portion and the compressor.

### CROSS REFERENCE TO RELATED APPLICATION

The present application is a continuation application of International Patent Application No. PCT/JP2023/010119 filed on Mar. 15, 2023, which designated the U.S. and claims the benefit of priority from Japanese Patent Application No. 2022-044794 filed on Mar. 21, 2022. The entire disclosures of all of the above applications are incorporated herein by reference.

### TECHNICAL FIELD

The present disclosure relates to a refrigeration cycle device.

### BACKGROUND

Conventionally, a refrigeration cycle device including a compressor, a radiator, a decompression unit, a single evaporator and an internal heat exchanger is known. The refrigeration cycle device controls the decompression unit in a manner that the degree of superheating of a refrigerant sucked into the compressor via the internal heat exchanger is a predetermined target degree of superheating.

### SUMMARY

According to an aspect of the present disclosure, a refrigeration cycle device includes a compressor, a radiator, a first decompression unit, a first evaporator, a second decompression unit, a second evaporator, and a refrigerant joining portion. The refrigerant joining portion is provided on a refrigerant suction side of the compressor, to join the refrigerant having passed through the first evaporator and the refrigerant having passed through the second evaporator. The first decompression unit is configured to regulate a degree of superheating of the refrigerant between the first evaporator and the refrigerant joining portion to a first target degree of superheating based on a first physical quantity having a correlation with the degree of superheating of the refrigerant flowing between the first evaporator and the refrigerant joining portion. In addition, the second decompression unit is configured to regulate a degree of superheating of the refrigerant between the refrigerant joining portion and the compressor to a second target degree of superheating based on a second physical quantity having a correlation with the degree of superheating of the refrigerant flowing between the refrigerant joining portion and the compressor.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic configuration diagram of a refrigeration cycle device according to a first embodiment;

FIG. 2 is an explanatory diagram for explaining a cycle configuration of a refrigeration cycle of the refrigeration cycle device according to the first embodiment;

FIG. 3 is a flowchart illustrating a flow of a compressor protection process performed by a control unit of the refrigeration cycle device according to the first embodiment;

FIG. 4 is a schematic configuration diagram of a refrigeration cycle device according to a second embodiment;

FIG. 5 is an explanatory diagram for explaining a cycle configuration of a refrigeration cycle of the refrigeration cycle device according to the second embodiment;

FIG. 6 is an explanatory diagram for explaining a cycle configuration of a refrigeration cycle of a refrigeration cycle device according to a first modification of the second embodiment;

FIG. 7 is an explanatory diagram for explaining a cycle configuration of a refrigeration cycle of a refrigeration cycle device according to a second modification of the second embodiment;

FIG. 8 is a schematic configuration diagram of a refrigeration cycle device according to a third embodiment;

FIG. 9 is an explanatory diagram for explaining a cycle configuration of a refrigeration cycle of the refrigeration cycle device according to the third embodiment;

FIG. 10 is an explanatory diagram for explaining an arrangement of a compressor, a first air conditioning evaporator, and a second air conditioning evaporator;

FIG. 11 is an explanatory diagram for explaining a state of each decompression valve in respective heat absorbing modes;

FIG. 12 is an explanatory diagram for explaining a cycle configuration of a refrigeration cycle of a refrigeration cycle device according to a first modification of the third embodiment;

FIG. 13 is an explanatory diagram for explaining a cycle configuration of a refrigeration cycle of a refrigeration cycle device according to a second modification of the third embodiment;

FIG. 14 is a schematic configuration diagram of a refrigeration cycle device according to a fourth embodiment;

FIG. 15 is an explanatory diagram for explaining a cycle configuration of a refrigeration cycle of the refrigeration cycle device according to the fourth embodiment;

FIG. 16 is an explanatory diagram for explaining a cycle configuration of a refrigeration cycle of a refrigeration cycle device according to a first modification of the fourth embodiment;

FIG. 17 is an explanatory diagram for explaining a cycle configuration of a refrigeration cycle of a refrigeration cycle device according to a second modification of the fourth embodiment;

FIG. 18 is an explanatory diagram for explaining a cycle configuration of a refrigeration cycle of a refrigeration cycle device according to a third modification of the fourth embodiment;

FIG. 19 is an explanatory diagram for explaining a cycle configuration of a refrigeration cycle of a refrigeration cycle device according to a fourth modification of the fourth embodiment; and

FIG. 20 is an explanatory diagram for explaining a cycle configuration of a refrigeration cycle of a refrigeration cycle device according to a fifth modification of the fourth embodiment.

### DESCRIPTION OF EMBODIMENTS

The present inventors have studied a refrigeration cycle device which performs an air conditioning in a space to be air conditioned such as an inside of a vehicle cabin and a temperature regulation of a heat generating device such as an in-vehicle battery.

However, it may be difficult to accurately regulate the temperature of each of the space to be air conditioned and the heat generating device to an appropriate temperature by a low-temperature side heat medium in which temperature regulation is performed by a single evaporator. In this case, it may be difficult to ensure both the air conditioning performance of the space to be air conditioned and the protection of the heat generating device.

In addition, in a case where the degree of superheating of a refrigerant sucked into a compressor is controlled by a decompression unit, the pressure and flow rate of the refrigerant flowing through an air conditioning evaporator cannot be regulated by the decompression unit, and thus the air conditioning performance of the space to be air conditioned may be insufficient. For this reason, it is also difficult to ensure both the air conditioning performance of the space to be air conditioned and the protection of the compressor.

An object of the present disclosure is to provide a refrigeration cycle device capable of appropriately protecting devices including a compressor and a heat generating device while ensuring or improving an air conditioning performance of a space to be air conditioned.

According to an exemplar of the present disclosure, a refrigeration cycle device includes a compressor, a radiator, a first decompression unit, a first evaporator, a second decompression unit, a second evaporator, and a refrigerant joining portion. The compressor is configured to compress and discharge a refrigerant. The radiator is configured to radiate heat of the refrigerant discharged from the compressor. The first decompression unit is configured to decompress the refrigerant having passed through the radiator. The first evaporator exchanges heat between the refrigerant decompressed by the first decompression unit and ventilation air to be supplied to a space to be air conditioned, and evaporates the refrigerant. The second decompression unit is disposed in parallel with the first decompression unit on a downstream side of the radiator to decompress the refrigerant having passed through the radiator. The second evaporator exchanges heat between the refrigerant decompressed by the second decompression unit and a heat medium that absorbs heat from at least one of a heat generating device or an external space, and evaporates the refrigerant. The refrigerant joining portion is provided on a refrigerant suction side of the compressor, to join the refrigerant having passed through the first evaporator and the refrigerant having passed through the second evaporator. The first decompression unit is configured to regulate a degree of superheating of the refrigerant between the first evaporator and the refrigerant joining portion to a first target degree of superheating based on a first physical quantity having a correlation with the degree of superheating of the refrigerant flowing between the first evaporator and the refrigerant joining portion. In addition, the second decompression unit is configured to regulate a degree of superheating of the refrigerant between the refrigerant joining portion and the compressor to a second target degree of superheating based on a second physical quantity having a correlation with the degree of superheating of the refrigerant flowing between the refrigerant joining portion and the compressor.

When the first evaporator for cooling the space to be air conditioned and the second evaporator for absorbing heat from a heat generating device or the like are provided, it is easy to respectively regulate the temperature of the space to be air conditioned and the heat generating device to appropriate temperatures. In particular, because the first decompression unit regulates the degree of superheating of the refrigerant on the refrigerant outlet port side of the first evaporator, a heat exchange between the refrigerant and the ventilation air in the first evaporator can be performed with high efficiency. In addition, because the second decompression unit regulates the degree of superheating of the refrigerant on the refrigerant suction side of the compressor, the temperature of the refrigerant on the refrigerant discharge side of the compressor can be suppressed, and deterioration of oil returnability can be suppressed.

Thus, according to the refrigeration cycle device of the present disclosure, it is possible to appropriately protect the compressor and the heat generating device while ensuring or improving the air conditioning performance of the space to be air conditioned.

Hereinafter, embodiments of the present disclosure will be described with reference to the drawings. In the following embodiments, parts that are the same or equivalent to matters described in the preceding embodiment are denoted by the same reference numerals, and redundant description may be omitted. In addition, in a case where only a part of the constituent elements is described in the embodiments, the constituent elements described in the preceding embodiment can be used for other parts of the constituent elements. In the following embodiments, the individual embodiments can be partially combined with each other even if not particularly specified as long as the combination is not particularly hindered.

### First Embodiment

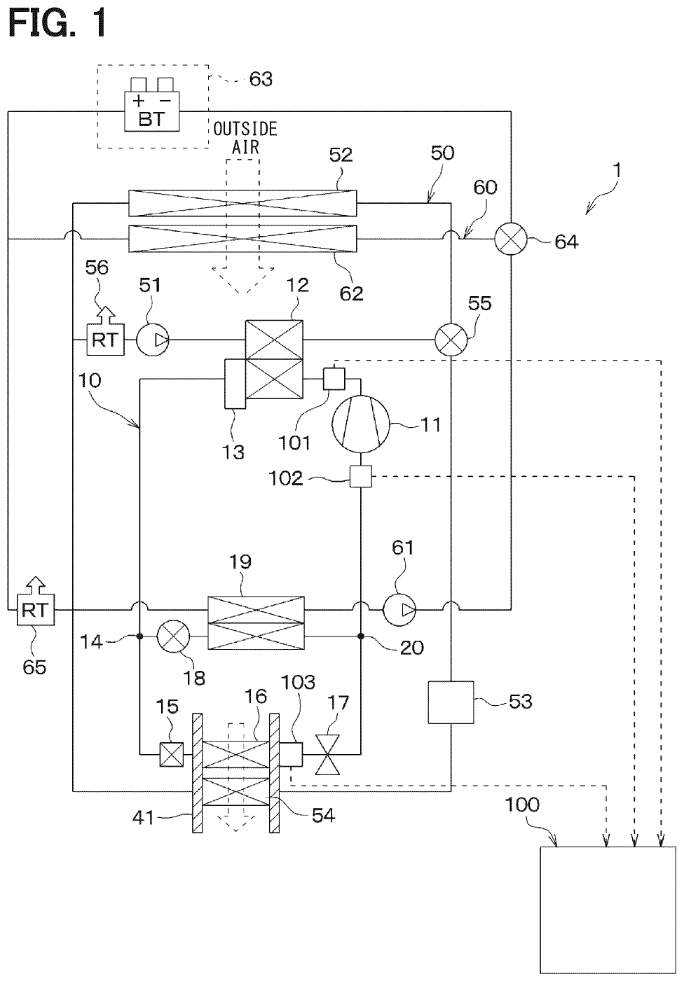

The present embodiment will be described with reference to FIGS. 1 to 3. In the present embodiment, an example in which a refrigeration cycle device 1 of the present disclosure is applied to a vehicle air conditioning system will be described. The refrigeration cycle device 1 is mounted on an electric vehicle that obtains vehicle-traveling driving force from a traveling electric motor. An electric vehicle can charge a large-capacity battery BT mounted on a vehicle with electric power supplied from an external power supply when the vehicle is stopped. The battery BT is a chargeable and dischargeable secondary battery. The battery BT includes, for example, a lithium ion battery that has high energy density, is lightweight, and is compact.

As illustrated in FIG. 1, the refrigeration cycle device 1 includes a vapor compression refrigeration cycle 10, a high-temperature side circuit 50, a low-temperature side circuit 60, and a control unit 100. The refrigeration cycle device 1 performs air condition in a vehicle cabin as a space to be air conditioned, and performs temperature regulation of a heat generating device 63 including the battery BT.

The refrigeration cycle 10 includes a compressor 11, a condenser 12, a liquid receiving portion 13, a refrigerant branch portion 14, a first decompression valve 15, an air conditioning evaporator 16, an evaporation pressure regulating valve 17, a second decompression valve 18, a device evaporator 19, and a refrigerant joining portion 20.

The refrigeration cycle 10 uses a refrigerant with a low global warming potential such as HFO-1234yf, as an example. Refrigerant oil for lubricating the compressor 11 is contained in the refrigerant. As the refrigerant oil, for example, a refrigerant oil with compatibility with a liquid-phase refrigerant such as PAG oil is used. A part of the refrigerant oil circulates in the cycle of the refrigeration cycle 10 together with the refrigerant.

The compressor 11 is a device that compresses and discharges a refrigerant. The compressor 11 includes an electric compressor driven by electric power supplied from the battery BT. The operation of the compressor 11 is controlled by a control signal output from the control unit 100.

The condenser 12 is connected to the refrigerant discharge side of the compressor 11. The condenser 12 is a radiator that exchanges heat between a high-temperature and high-pressure refrigerant (hereinafter, also referred to as “high-pressure refrigerant”) discharged from the compressor 11 and a high-temperature side heat medium flowing through the high-temperature side circuit 50 to radiate heat of the high-pressure refrigerant to the high-temperature side heat medium. The high-pressure refrigerant radiates heat to the high-temperature side heat medium and condenses when passing through the condenser 12.

The high-temperature side heat medium is a fluid flowing through the high-temperature side circuit 50. The high-temperature side heat medium is a liquid-phase fluid that does not change in phase when flowing through the high-temperature side circuit 50. As the high-temperature side heat medium, for example, a liquid or antifreeze liquid containing ethylene glycol is used.

Here, the high-temperature side circuit 50 is a circuit for radiating heat from the high-temperature side heat medium to the outside and performing air heating in the vehicle cabin using the high-temperature side heat medium. The high-temperature side circuit 50 includes a high-temperature side pump 51, a high-temperature side radiator 52, an electric heater 53, a heater core 54, a first flow path switching valve 55, and a high-temperature side reserve tank 56.

The high-temperature side pump 51 sucks and feeds the high-temperature side heat medium toward the condenser 12 side to circulate the high-temperature side heat medium in the high-temperature side circuit 50. The high-temperature side pump 51 is an electric pump driven by electric power supplied from the battery BT. The high-temperature side pump 51 also functions as a regulating unit that regulates the flow rate of the high-temperature side heat medium flowing through the high-temperature side circuit 50.

The high-temperature side radiator 52 exchanges heat between the high-temperature side heat medium heated by the condenser 12 and the outside air outside the vehicle cabin to radiate heat from the high-temperature side heat medium. The high-temperature side radiator 52 is disposed, for example, on the front side in the traveling direction of the vehicle, and the traveling wind flows in when the vehicle travels.

The electric heater 53 is disposed in parallel with the high-temperature side radiator 52 in the high-temperature side circuit 50 with respect a flow of the high-temperature side heat medium flowing from the high-temperature side pump 51. The electric heater 53 heats the high-temperature side heat medium. The electric heater 53 is an auxiliary heat source that heats the high-temperature side heat medium in a situation where the high-temperature side heat medium cannot be sufficiently heated by the condenser 12. The energization state of the electric heater 53 is controlled by a control signal output from the control unit 100.

The heater core 54 is disposed in series with the electric heater 53. The heater core 54 is disposed inside a casing 41 of an air conditioning unit 40. The heater core 54 exchanges heat between the high-temperature side heat medium heated by the condenser 12 and the ventilation air to be supplied to the vehicle cabin, thereby generating conditioned air with a desired temperature.

The first flow path switching valve 55 functions as a flow path switching unit that switches the flow path of the high-temperature side heat medium. The first flow path switching valve 55 is provided at a branch portion that branches the flow path of the high-temperature side heat medium into a flow path on the high-temperature side radiator 52 side and a flow path on the heater core 54 side in the high-temperature side circuit 50. The first flow path switching valve 55 includes an electromagnetic valve, and its operation is controlled by a control signal output from the control unit 100. In the high-temperature side circuit 50, instead of the first flow path switching valve 55, a flow rate regulating valve that can regulate the flow rate of the high-temperature side heat medium flowing to the high-temperature side radiator 52 and the flow rate of the high-temperature side heat medium flowing to the heater core 54 may be disposed.

The high-temperature side reserve tank 56 is a tank that stores an excessive high-temperature side heat medium. The high-temperature side reserve tank 56 is disposed on the inlet port side of the high-temperature side heat medium in the high-temperature side pump 51.

The liquid receiving portion 13 is connected to the refrigerant outlet port side of the condenser 12. The liquid receiving portion 13 stores an excessive refrigerant in the refrigeration cycle 10. The liquid receiving portion 13 separates the refrigerant flowing out of the condenser 12 into gas and liquid, and causes the separated liquid-phase refrigerant to flow downstream. The liquid receiving portion 13 may be constituted by either a receiver tank in which the refrigerant inlet and outlet port is provided upward or a modulator tank in which the refrigerant inlet and outlet port is provided downward.

The refrigerant branch portion 14 that branches the flow path of the refrigerant into two is provided on the refrigerant outlet port side of the liquid receiving portion 13. The refrigerant branch portion 14 includes a three-way valve having one refrigerant inlet port and two refrigerant outlet ports. The first decompression valve 15 is connected to one refrigerant outlet port side of the refrigerant branch portion 14, and the second decompression valve 18 is connected to the other refrigerant outlet port side of the refrigerant branch portion.

The first decompression valve 15 is a first decompression unit that decompresses the refrigerant having passed through the condenser 12. Specifically, the first decompression valve 15 decompresses the liquid-phase refrigerant that has passed through the condenser 12 and is stored in the liquid receiving portion 13. The first decompression valve 15 is an electric variable throttle whose operation is controlled by a control signal output from the control unit 100, and includes a valve body and an electric actuator. The first decompression valve 15 is configured as a variable throttle with a full-close function capable of substantially stopping the flow of the refrigerant. The operation of the first decompression valve 15 will be described later.

The air conditioning evaporator 16 is connected to the refrigerant outlet port side of the first decompression valve 15. The air conditioning evaporator 16 is disposed inside the casing 41 of the air conditioning unit 40 together with the heater core 54. The air conditioning evaporator 16 exchanges heat between the refrigerant decompressed by the first decompression valve 15 and ventilation air to be supplied to the vehicle cabin to evaporate the refrigerant. In the air conditioning evaporator 16, the refrigerant absorbs heat from the air to be supplied to the vehicle cabin and evaporates, thereby cooling the air. The air having passed through the air conditioning evaporator 16 passes through the heater core 54 and is then supplied to the vehicle cabin as conditioned air. In the present embodiment, the air conditioning evaporator 16 corresponds to “first evaporator”.

The evaporation pressure regulating valve 17 is connected to the refrigerant outlet port side of the air conditioning evaporator 16. The evaporation pressure regulating valve 17 is a pressure regulating unit that maintains the evaporation pressure of the refrigerant in the air conditioning evaporator 16 at a predetermined pressure or higher. The evaporation pressure regulating valve 17 is configured to regulate the evaporation pressure of the refrigerant in the air conditioning evaporator 16 in a manner that the temperature of the air conditioning evaporator 16 is a temperature (for example, 1° C.) at which frosting of the air conditioning evaporator 16 is suppressed, for example. The evaporation pressure regulating valve 17 may be configured to drive the valve body by a mechanical drive mechanism using a bellows or the like, or may be configured to drive the valve body by an electric motor.

The second decompression valve 18 is a second decompression unit that decompresses the refrigerant having passed through the condenser 12. Specifically, the second decompression valve 18 decompresses the liquid-phase refrigerant that has passed through the condenser 12 and is stored in the liquid receiving portion 13.

The second decompression valve 18 is disposed in parallel with the first decompression valve 15. The second decompression valve 18 is an electric variable throttle whose operation is controlled by a control signal output from the control unit 100, and includes a valve body and an electric actuator. The second decompression valve 18 is configured as a variable throttle with the full-close function capable of substantially stopping the flow of the refrigerant. The operation of the second decompression valve 18 will be described later.

The device evaporator 19 is connected to the refrigerant outlet port side of the second decompression valve 18. The device evaporator 19 is a chiller that exchanges heat between the refrigerant decompressed by the second decompression valve 18 and a low-temperature side heat medium that absorbs heat from at least one of the heat generating device 63 or the outside air outside the vehicle cabin as the external space to evaporate the refrigerant. In the present embodiment, the outside of the vehicle cabin corresponds to “external space”, and the low-temperature side heat medium corresponds to “heat absorbing medium” that absorbs heat from at least one of the heat generating device 63 or the external space. In the present embodiment, the device evaporator 19 corresponds to “second evaporator”.

The low-temperature side heat medium is a fluid flowing through the low-temperature side circuit 60. The low-temperature side heat medium is a liquid-phase fluid that does not change in phase when flowing through the low-temperature side circuit 60. As the low-temperature side heat medium, for example, a liquid or antifreeze liquid containing ethylene glycol is used. As the low-temperature side heat medium, oil with electrical insulation properties may be used.

The low-temperature side circuit 60 is a circuit for regulating the temperature of the heat generating device 63 using the low-temperature side heat medium and absorbing heat from the external space using the low-temperature side heat medium. The low-temperature side circuit 60 includes a low-temperature side pump 61, a low-temperature side radiator 62, the heat generating device 63 to be temperature-controlled, a second flow path switching valve 64, and a low-temperature side reserve tank 65.

The low-temperature side pump 61 sucks and feeds the low-temperature side heat medium toward the device evaporator 19 to circulate the low-temperature side heat medium in the low-temperature side circuit 60. The low-temperature side pump 61 is an electric pump driven by electric power supplied from the battery BT. The low-temperature side pump 61 also functions as a regulating unit that regulates the flow rate of the low-temperature side heat medium flowing through the low-temperature side circuit 60.

The low-temperature side radiator 62 exchanges heat between the low-temperature side heat medium having passed through the device evaporator 19 and the outside air outside the vehicle cabin to absorb heat from the outside air. The low-temperature side radiator 62 is disposed, for example, on the front side in the traveling direction of the vehicle together with the high-temperature side radiator 52. The high-temperature side radiator 52 and the low-temperature side radiator 62 are arranged in series in this order in the flow direction of the outside air. The high-temperature side radiator 52 and the low-temperature side radiator 62 are connected to each other so as to be heat-transferable by a common heat transfer fin (not illustrated).

The heat generating device 63 is disposed in parallel with the low-temperature side radiator 62 in the low-temperature side circuit 60. The heat generating device 63 is an in-vehicle device including the battery BT as a battery. The heat generating device 63 is disposed so as to be able to exchange heat with the low-temperature side heat medium. The heat generating device 63 is maintained at an appropriate temperature by radiating heat to the low-temperature side heat medium. In other words, the low-temperature side circuit 60 absorbs heat from the heat generating device 63 via the low-temperature side heat medium. The in-vehicle device constituting the heat generating device 63 may be different from the device described above.

The second flow path switching valve 64 functions as a flow path switching unit that switches the flow path of the low-temperature side heat medium. The second flow path switching valve 64 is provided at a branch portion that branches the flow path of the low-temperature side heat medium into a flow path on the low-temperature side radiator 62 side and a flow path on the heat generating device 63 side in the low-temperature side circuit 60. The second flow path switching valve 64 includes an electromagnetic valve, and its operation is controlled by a control signal output from the control unit 100. In the low-temperature side circuit 60, instead of the second flow path switching valve 64, a flow rate regulating valve that can regulate the flow rate of the low-temperature side heat medium flowing to the low-temperature side radiator 62 and the flow rate of the low-temperature side heat medium flowing to the heat generating device 63 may be disposed.

The low-temperature side reserve tank 65 is a tank that stores an excessive low-temperature side heat medium. The low-temperature side reserve tank 65 is disposed in a flow path from the joining portion of the flow path of the low-temperature side radiator 62 and the flow path on the heat generating device 63 side to an inlet port of the low-temperature side pump 61.

The refrigerant joining portion 20 is connected to the refrigerant outlet port side of the device evaporator 19. The refrigerant joining portion 20 is a three-way valve that joins the refrigerant having passed through the device evaporator 19 and the refrigerant having passed through the air conditioning evaporator 16. Specifically, the refrigerant joining portion 20 joins the refrigerant having passed through the device evaporator 19 and the refrigerant having passed through the evaporation pressure regulating valve 17 located downstream of the air conditioning evaporator 16. The refrigerant outlet port side of the refrigerant joining portion 20 is connected to a refrigerant suction port of the compressor 11.

The refrigeration cycle device 1 with such a configuration includes the control unit 100 that controls various components. The control unit 100 includes a microcomputer including a processor and a memory, and peripheral circuits thereof. The control unit 100 performs various calculations and processing on the basis of a control program stored in the memory. The memory of the control unit 100 includes a non-transitory tangible storage medium.

Various operation switches (not illustrated) are connected to the input side of the control unit 100, and operation signals of the various operation switches are input. The various operation switches include an air conditioner switch, a room temperature control switch, and the like. The air conditioner switch is a switch that sets whether or not to cool air in the air conditioning unit 40. The room temperature control switch is a switch that sets a set temperature in the vehicle cabin.

An air-conditioning control sensor group and a device temperature control sensor group are connected to the input side of the control unit 100. The air-conditioning control sensor group includes a discharge-side sensor 101 provided on the refrigerant discharge side of the compressor 11, a suction-side sensor 102 provided on the refrigerant suction side of the compressor 11, and an evaporator-side sensor 103 provided on the refrigerant outlet port side of the air conditioning evaporator 16.

The discharge-side sensor 101 is a pressure temperature sensor that detects the pressure and temperature of the refrigerant discharged from the compressor 11. In the discharge-side sensor 101, the pressure detection unit and the temperature detection unit may be integrally formed, or may be separately formed. The discharge-side sensor 101 is mainly provided to protect the compressor 11. The discharge-side sensor 101 is disposed at a refrigerant discharge port of the compressor 11 or a refrigerant path from the refrigerant discharge port to a refrigerant inlet port of the condenser 12 in the refrigeration cycle 10.

The suction-side sensor 102 is a pressure temperature sensor that detects the pressure and temperature of the refrigerant sucked into the compressor 11. In the suction-side sensor 102, the pressure detection unit and the temperature detection unit may be integrally formed, or may be separately formed. The suction-side sensor 102 is provided to detect the degree of superheating of the refrigerant sucked into the compressor 11. The suction-side sensor 102 is disposed in a refrigerant path from the refrigerant joining portion 20 to the refrigerant suction port of the compressor 11 in the refrigeration cycle 10. In the present embodiment, the pressure and temperature of the refrigerant sucked into the compressor 11 correspond to “second physical quantity” with a correlation with the degree of superheating of the refrigerant flowing between the refrigerant joining portion 20 and the compressor 11. In the present embodiment, the suction-side sensor 102 corresponds to “second physical quantity detection unit”.

The evaporator-side sensor 103 is a pressure temperature sensor that detects the pressure and temperature of the refrigerant having passed through the air conditioning evaporator 16. In the evaporator-side sensor 103, the pressure detection unit and the temperature detection unit may be integrally formed, or may be separately formed. The evaporator-side sensor 103 is provided to detect the degree of superheating of the refrigerant having passed through the air conditioning evaporator 16. The evaporator-side sensor 103 is disposed in a refrigerant path from the air conditioning evaporator 16 to the refrigerant joining portion 20 in the refrigeration cycle 10. In the present embodiment, the pressure and temperature of the refrigerant having passed through the air conditioning evaporator 16 correspond to “first physical quantity” with a correlation with the degree of superheating of the refrigerant flowing between the air conditioning evaporator 16 and the refrigerant joining portion 20. In the present embodiment, the evaporator-side sensor 103 corresponds to “first physical quantity detection unit”.

In the refrigeration cycle 10 of the present embodiment, the evaporation pressure regulating valve 17 is disposed in the refrigerant path from the air conditioning evaporator 16 to the refrigerant joining portion 20, and the pressure of the refrigerant changes at the front and behind of the evaporation pressure regulating valve 17. Nevertheless, if the evaporator-side sensor 103 is disposed downstream of the evaporation pressure regulating valve 17, the detection accuracy of the degree of superheating at a refrigerant outlet port of the air conditioning evaporator 16 decreases. In order to avoid such a situation, the evaporator-side sensor 103 of the present embodiment is disposed in the refrigerant path from the air conditioning evaporator 16 to the evaporation pressure regulating valve 17 in the refrigeration cycle 10. The evaporator-side sensor 103 is disposed immediately behind the refrigerant outlet port of the air conditioning evaporator 16 to minimize the influence of thermal damage. The location immediately behind the refrigerant outlet port of the air conditioning evaporator 16 is a portion in which the state of the refrigerant is substantially the same as the state of the refrigerant at the refrigerant outlet port of the air conditioning evaporator 16 on the downstream side of the air conditioning evaporator 16. For example, the location immediately behind the refrigerant outlet port of the air conditioning evaporator 16 can be interpreted as a portion located upstream of the intermediate point between the air conditioning evaporator 16 and the evaporation pressure regulating valve 17 in the refrigerant path from the air conditioning evaporator 16 to the evaporation pressure regulating valve 17.

The compressor 11, the first decompression valve 15, the second decompression valve 18, the high-temperature side pump 51, the electric heater 53, the first flow path switching valve 55, the low-temperature side pump 61, the second flow path switching valve 64, and the like are connected to the output side of the control unit 100. The control unit 100 controls operations of various control target devices on the basis of sensor outputs of the air-conditioning control sensor group and the device temperature control sensor group, operation signals of various operation switches, and the like.

The control unit 100 calculates ventilation air to be supplied to the vehicle cabin on the basis of a set temperature, an outside air temperature, an inside air temperature, a solar radiation amount, and the like, and controls the refrigerant discharge performance of the compressor 11 in a manner that the temperature of the ventilation air to be supplied to the vehicle cabin approaches a target blowing temperature. In addition, the control unit 100 controls the operation of the first decompression valve 15 and the operation of the second decompression valve 18 in a manner that the low-pressure refrigerant in the refrigeration cycle 10 has a desired degree of superheating in a scene in which the refrigerant flows through the evaporators 16 and 19.

For example, in order to avoid liquid back to the compressor 11, it is conceivable to control the operation of each of the first decompression valve 15 and the second decompression valve 18 on the basis of a sensor output of the suction-side sensor 102 in a manner that the gas refrigerant with the degree of superheating is sucked into the compressor 11.

However, in a case where the degree of superheating of the refrigerant sucked into the compressor 11 is controlled by the decompression valves 15 and 18, the pressure regulation and flow rate regulation of the refrigerant flowing through the air conditioning evaporator 16 by the decompression valves 15 and 18 is restricted, and thus the air conditioning performance of the space to be air conditioned is insufficient.

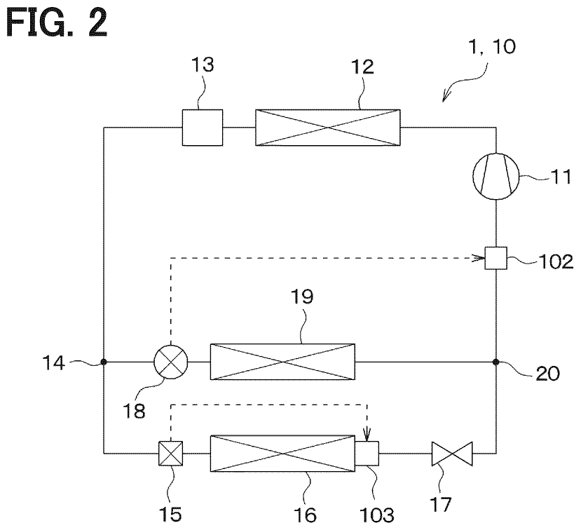

In view of the above, as illustrated in FIG. 2, the refrigeration cycle device 1 is configured in a manner that the degree of superheating of the refrigerant having passed through the air conditioning evaporator 16 is regulated by the first decompression valve 15, and the degree of superheating of the refrigerant sucked into the compressor 11 is regulated by the second decompression valve 18.

Specifically, the control unit 100 obtains the degree of superheating of the refrigerant between the air conditioning evaporator 16 and the refrigerant joining portion 20 on the basis of a sensor output of the evaporator-side sensor 103, and operates the first decompression valve 15 in a manner that the degree of superheating approaches a first target degree of superheating. In this manner, the first decompression valve 15 regulates the degree of superheating of the refrigerant between the air conditioning evaporator 16 and the refrigerant joining portion 20 to the first target degree of superheating on the basis of the first physical quantity with a correlation with the degree of superheating of the refrigerant flowing between the air conditioning evaporator 16 and the refrigerant joining portion 20.

In addition, the control unit 100 obtains the degree of superheating of the refrigerant between the refrigerant joining portion 20 and the compressor 11 on the basis of the sensor output of the suction-side sensor 102, and operates the second decompression valve 18 in a manner that the degree of superheating approaches a second target degree of superheating. In this manner, the second decompression valve 18 regulates the degree of superheating of the refrigerant between the refrigerant joining portion 20 and the compressor 11 to the second target degree of superheating on the basis of the second physical quantity with a correlation with the degree of superheating of the refrigerant flowing between the refrigerant joining portion 20 and the compressor 11.

The control unit 100 of the present embodiment switches the operation mode of the refrigeration cycle device 1 on the basis of sensor outputs of the air-conditioning control sensor group and the device temperature control sensor group, operation signals of various operation switches, and the like. For example, the control unit 100 calculates a target blowing temperature of conditioned air to be supplied to the vehicle cabin from the air conditioning unit 40, and switches the operation mode of the refrigeration cycle device 1 to any one of an air-cooling mode, an air-heating mode, and a dehumidifying and air-heating mode on the basis of the target blowing temperature and the like. Hereinafter, an example of operation in each of the air-cooling mode, the air-heating mode, and the dehumidifying and air-heating mode will be described.

[Air-Cooling Mode]

When conditions for performing the air-cooling mode are satisfied, the control unit 100 determines control signals to be output to various devices connected to the control unit 100 on the basis of the target blowing temperature, the sensor outputs of the various sensor groups, and the like.

For example, the control unit 100 drives the compressor 11, controls the first decompression valve 15 to be in a throttled state, and controls the second decompression valve 18 to be in a fully closed state. The control unit 100 determines the control signal to be output to the first decompression valve 15 in a manner that the degree of superheating on the refrigerant outlet port side of the air conditioning evaporator 16 is a predetermined first target degree of superheating. In addition, the control unit 100 drives the high-temperature side pump 51 and controls the first flow path switching valve 55 in a manner that the high-temperature side heat medium flows through the high-temperature side radiator 52.

In the refrigeration cycle 10 in the air-cooling mode, the refrigerant discharged from the compressor 11 flows into the condenser 12. The refrigerant flowing into the condenser 12 radiates heat to the high-temperature side heat medium flowing through the high-temperature side circuit 50. As a result, the refrigerant flowing through the condenser 12 is cooled and condensed. The high-temperature side heat medium radiates heat to outside air when passing through the high-temperature side radiator 52.

The refrigerant having passed through the condenser 12 is separated into gas and liquid in the liquid receiving portion 13, and the liquid-phase refrigerant that is excessive in the cycle is stored inside the liquid receiving portion 13. The liquid-phase refrigerant stored in the liquid receiving portion 13 is decompressed by the first decompression valve 15. The refrigerant decompressed by the first decompression valve 15 flows into the air conditioning evaporator 16, absorbs heat from ventilation air to be supplied to the vehicle cabin, and evaporates. As a result, the ventilation air to be supplied to the vehicle cabin is cooled to a desired temperature. The refrigerant having passed through the air conditioning evaporator 16 flows to the suction side of the compressor 11 and is compressed again by the compressor 11.

As described above, in the air-cooling mode, the air conditioning evaporator 16 exchanges heat between the refrigerant and the ventilation air to be supplied to the vehicle cabin to cool the ventilation air to be supplied to the vehicle cabin. As a result, the air in the vehicle cabin is cooled.

[Device Cooling in Air-Cooling Mode]

Here, for example, in the air-cooling mode, when the conditions for cooling the heat generating device 63 are satisfied, the control unit 100 controls the second decompression valve 18 to be in the throttled state. The control unit 100 determines the control signal to be output to the second decompression valve 18 in a manner that the degree of superheating of the refrigerant sucked into the compressor 11 is a predetermined first target degree of superheating. In addition, the control unit 100 drives the low-temperature side pump 61 and controls the second flow path switching valve 64 in a manner that the low-temperature side heat medium flows through the low-temperature side radiator 62.

When such control is executed, a part of the liquid-phase refrigerant stored in the liquid receiving portion 13 flows into the second decompression valve 18 and is decompressed. The refrigerant decompressed by the second decompression valve 18 absorbs heat from the low-temperature side heat medium and evaporates in the device evaporator 19. As a result, the low-temperature side heat medium flowing through the low-temperature side circuit 60 is cooled. When the low-temperature side heat medium cooled by the device evaporator 19 circulates through the low-temperature side circuit 60, the low-temperature side heat medium exchanges heat with the heat generating device 63 to cool the heat generating device 63. When the conditions for cooling the heat generating device 63 are satisfied in a case where air conditioning in the vehicle cabin is not performed, the control unit 100 controls the first decompression valve 15 to be in the fully closed state and controls the second decompression valve 18 to be in the throttled state.

### [Air-Heating Mode]

When conditions for performing the air-heating mode are satisfied, the control unit 100 determines control signals to be output to various devices connected to the control unit 100 on the basis of the target blowing temperature, the sensor outputs of the various sensor groups, and the like.

For example, the control unit 100 drives the compressor 11, controls the first decompression valve 15 to be in the fully closed state, and controls the second decompression valve 18 to be in the throttled state. The control unit 100 determines the control signal to be output to the second decompression valve 18 in a manner that the degree of superheating of the refrigerant sucked into the compressor 11 is a predetermined second target degree of superheating. In addition, the control unit 100 drives the high-temperature side pump 51 and controls the first flow path switching valve 55 in a manner that the high-temperature side heat medium flows through the heater core 54. Furthermore, the control unit 100 drives the low-temperature side pump 61 and controls the second flow path switching valve 64 in a manner that the low-temperature side heat medium flows through the low-temperature side radiator 62.

In the refrigeration cycle 10 in the air-heating mode, the refrigerant discharged from the compressor 11 flows into the condenser 12. The refrigerant flowing into the condenser 12 radiates heat to the high-temperature side heat medium flowing through the high-temperature side circuit 50. As a result, the refrigerant flowing through the condenser 12 is cooled and condensed. The high-temperature side heat medium radiates heat to ventilation air to be supplied to the vehicle cabin in the heater core 54. As a result, the ventilation air to be supplied to the vehicle cabin is heated.

The refrigerant having passed through the condenser 12 is separated into gas and liquid in the liquid receiving portion 13, and the liquid-phase refrigerant that is excessive in the cycle is stored inside the liquid receiving portion 13. The liquid-phase refrigerant stored in the liquid receiving portion 13 is decompressed by the second decompression valve 18. The refrigerant decompressed by the second decompression valve 18 flows into the device evaporator 19, absorbs heat from the low-temperature side heat medium, and evaporates in the device evaporator 19. The refrigerant having passed through the device evaporator 19 flows to the suction side of the compressor 11 and is compressed again by the compressor 11.

Here, the low-temperature side heat medium having passed through the device evaporator 19 absorbs heat from the outside air when passing through the low-temperature side radiator 62. As a result, the refrigerant flowing through the device evaporator 19 absorbs heat from the outside air via the low-temperature side heat medium.

As described above, in the air-heating mode, the refrigerant discharged from the compressor 11 radiates heat to the high-temperature side heat medium in the condenser 12, and the high-temperature side heat medium in the high-temperature side circuit 50 radiates heat to the air to be supplied to the vehicle cabin in the heater core 54 to heat the ventilation air to be supplied to the vehicle cabin. As a result, the air in the vehicle cabin is heated.

In the air-heating mode, the low-temperature side heat medium flowing through the low-temperature side radiator 62 absorbs heat from the outside air, so that frost may be formed on the low-temperature side radiator 62. If frost is formed on the low-temperature side radiator 62, heat exchange between the low-temperature side heat medium and the outside air is restricted.

On the other hand, the low-temperature side radiator 62 of the present embodiment is connected to the high-temperature side radiator 52 so as to be heat-transferable by a common heat transfer fin. For this reason, for example, when the vehicle is stopped after the air-heating mode is performed, defrosting of the low-temperature side radiator 62 can be performed using the heat remaining in the high-temperature side heat medium in the high-temperature side circuit 50.

[Device Cooling in Air-Heating Mode]

When the conditions for cooling the heat generating device 63 are satisfied in the air-heating mode, the control unit 100 controls the second flow path switching valve 64 in a manner that the low-temperature side heat medium flows to the heat generating device 63 side. The control unit 100 may control the second flow path switching valve 64 in a manner that the low-temperature side heat medium flows to both the heat generating device 63 and the low-temperature side radiator 62.

In this case, the refrigerant decompressed by the second decompression valve 18 flows into the device evaporator 19, absorbs heat from the low-temperature side heat medium, and evaporates in the device evaporator 19. As a result, the low-temperature side heat medium flowing through the low-temperature side circuit 60 is cooled. When the low-temperature side heat medium cooled by the device evaporator 19 circulates through the low-temperature side circuit 60, the low-temperature side heat medium exchanges heat with the heat generating device 63 to cool the heat generating device 63. The refrigerant flowing through the device evaporator 19 absorbs heat from the heat generating device 63 via the low-temperature side heat medium.

### [Dehumidifying and Air-Heating Mode]

When conditions for performing the dehumidifying and air-heating mode are satisfied, the control unit 100 determines control signals to be output to various devices connected to the control unit 100 on the basis of the target blowing temperature, the sensor outputs of the various sensor groups, and the like.

For example, the control unit 100 drives the compressor 11, controls the first decompression valve 15 to be in the throttled state, and controls the second decompression valve 18 to be in the fully closed state. The control unit 100 determines the degree of superheating on the refrigerant outlet port side of the air conditioning evaporator 16 to be a predetermined first target degree of superheating. In addition, the control unit 100 drives the high-temperature side pump 51 and controls the first flow path switching valve 55 in a manner that the high-temperature side heat medium flows through the heater core 54.

In the refrigeration cycle 10 in the dehumidifying and air-heating mode, the refrigerant discharged from the compressor 11 flows into the condenser 12. The refrigerant flowing into the condenser 12 radiates heat to the high-temperature side heat medium flowing through the high-temperature side circuit 50. As a result, the refrigerant flowing through the condenser 12 is cooled and condensed. The high-temperature side heat medium radiates heat to ventilation air to be supplied to the vehicle cabin in the heater core 54. As a result, the ventilation air to be supplied to the vehicle cabin is heated.

The refrigerant having passed through the condenser 12 is separated into gas and liquid in the liquid receiving portion 13, and the liquid-phase refrigerant that is excessive in the cycle is stored inside the liquid receiving portion 13. The liquid-phase refrigerant stored in the liquid receiving portion 13 is decompressed by the second decompression valve 18. The refrigerant decompressed by the first decompression valve 15 flows into the air conditioning evaporator 16, absorbs heat from air before being heated by the heater core 54, and evaporates. As a result, the ventilation air to be supplied to the vehicle cabin is dehumidified. The refrigerant having passed through the air conditioning evaporator 16 flows to the suction side of the compressor 11 and is compressed again by the compressor 11.

As described above, in the dehumidifying and air-heating mode, the refrigerant discharged from the compressor 11 radiates heat to the high-temperature side heat medium in the condenser 12, and the high-temperature side heat medium in the high-temperature side circuit 50 radiates heat to the air to be supplied to the vehicle cabin in the heater core 54. In the dehumidifying and air-heating mode, the refrigerant decompressed by the first decompression valve 15 exchanges heat with the ventilation air to be supplied to the vehicle cabin to be evaporated in the air conditioning evaporator 16. As a result, the air dehumidified by the air conditioning evaporator 16 can be heated by the heater core 54 and blown into the vehicle cabin.

[Device Cooling in Dehumidifying and Air-Heating Mode]

Here, for example, in the dehumidifying and air-heating mode, when the conditions for cooling the heat generating device 63 are satisfied, the control unit 100 controls the second decompression valve 18 to be in the throttled state. The control unit 100 determines the control signal to be output to the second decompression valve 18 in a manner that the degree of superheating of the refrigerant sucked into the compressor 11 is a predetermined second target degree of superheating. In addition, the control unit 100 drives the low-temperature side pump 61 and controls the second flow path switching valve 64 in a manner that the low-temperature side heat medium flows through the low-temperature side radiator 62.

When such control is executed, a part of the liquid-phase refrigerant stored in the liquid receiving portion 13 flows into the second decompression valve 18 and is decompressed. The refrigerant decompressed by the second decompression valve 18 absorbs heat from the low-temperature side heat medium and evaporates in the device evaporator 19. As a result, the low-temperature side heat medium flowing through the low-temperature side circuit 60 is cooled. When the low-temperature side heat medium cooled by the device evaporator 19 circulates through the low-temperature side circuit 60, the low-temperature side heat medium exchanges heat with the heat generating device 63 to cool the heat generating device 63.

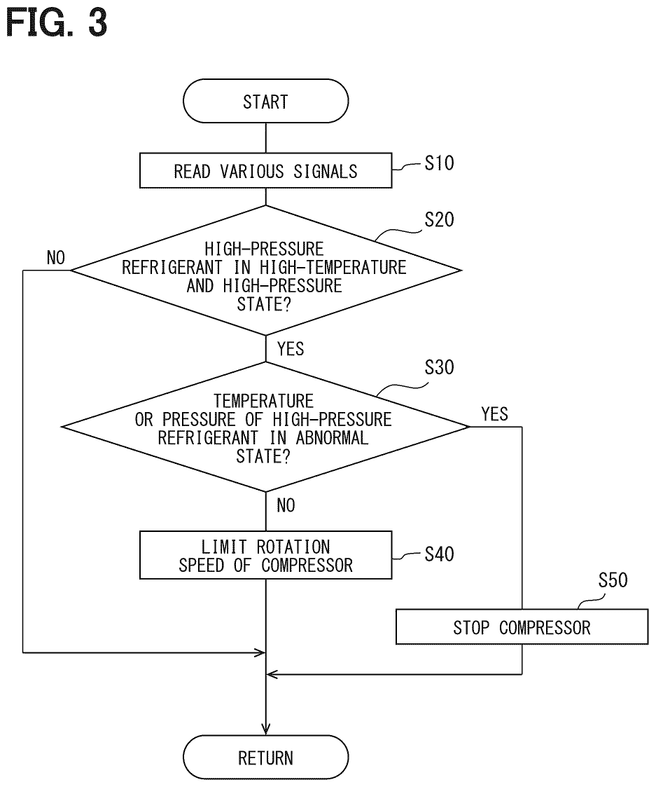

Here, the control unit 100 of the present embodiment performs a protection process for protecting the compressor 11 at the time of air conditioning in the vehicle cabin or at the time of temperature control of the heat generating device 63. This protection process will be described with reference to FIG. 3. The control routine illustrated in FIG. 3 is performed by the control unit 100 periodically or irregularly at the time of air conditioning in the vehicle cabin or at the time of temperature control of the heat generating device 63.

As illustrated in FIG. 3, in step S10, the control unit 100 reads various signals generated by various sensors and various switches connected to the input side of the control unit 100. Specifically, the control unit 100 reads various signals including a sensor output of the discharge-side sensor 101.

Next, in step S20, the control unit 100 determines whether or not the high-pressure refrigerant in the refrigeration cycle 10 is in a high-temperature and high-pressure state. For example, the control unit 100 compares the pressure of the high-pressure refrigerant detected by the discharge-side sensor 101 with a first reference pressure, and compares the temperature of the high-pressure refrigerant detected by the discharge-side sensor 101 with a first reference temperature. The control unit 100 then determines that the high-pressure refrigerant is in the high-temperature and high-pressure state in a case where the pressure of the high-pressure refrigerant is equal to or higher than the first reference pressure or the temperature of the high-pressure refrigerant is equal to or higher than the first reference temperature. The first reference pressure and the first reference temperature are set in consideration of, for example, the pressure resistance and heat resistance of the compressor 11, and are stored in a memory in advance. The determination process in step S20 may be configured to determine whether or not the high-pressure refrigerant is in the high-temperature and high-pressure state by another method. For example, the temperature or the like of the high-pressure refrigerant may be estimated on the basis of the rotation speed of the compressor 11 and the temperature or the like of the refrigerant sucked into the compressor 11, and whether or not the high-pressure refrigerant is in the high-temperature and high-pressure state may be determined on the basis of the estimation result.

If the high-pressure refrigerant in the refrigeration cycle 10 is not in the high-temperature and high-pressure state, the control unit 100 exits the protection process. On the other hand, if the high-pressure refrigerant is in the high-temperature and high-pressure state, the control unit 100 proceeds to step S30 and determines whether or not the pressure or temperature of the high-pressure refrigerant is in an abnormal state.

For example, the control unit 100 compares the pressure of the high-pressure refrigerant detected by the discharge-side sensor 101 with a second reference pressure higher than the first reference pressure, and compares the temperature of the high-pressure refrigerant detected by the discharge-side sensor 101 with a second reference temperature higher than the first reference temperature. The control unit 100 then determines that the pressure or temperature of the high-pressure refrigerant is in the abnormal state in a case where the pressure of the high-pressure refrigerant is equal to or higher than the second reference pressure or the temperature of the high-pressure refrigerant is equal to or higher than the second reference temperature. The second reference pressure and the second reference temperature are stored in the memory in advance. The determination process in step S30 may be configured to determine whether or not the pressure or temperature of the high-pressure refrigerant is in the abnormal state by another method.

If the pressure and temperature of the high-pressure refrigerant are not in the abnormal state, the control unit 100 proceeds to step S40, limits the rotation speed of the compressor 11, and exits the protection process. The control unit 100 limits the rotation speed of the compressor 11, for example, by reducing the upper limit value of the rotation speed of the compressor 11. In the process in step S40, the rotation of the compressor 11 may be limited by another method. In the process in step S40, the second target degree of superheating of the refrigerant sucked into the compressor 11 controlled by the second decompression valve 18 may be reduced in a manner that the temperature of the refrigerant sucked into the compressor 11 is reduced.

On the other hand, if the pressure or temperature of the high-pressure refrigerant is in the abnormal state, the control unit 100 proceeds to step S50, stops the compressor 11, and exits the protection process. In this case, it is desirable that the control unit 100 notify a user or the like of the abnormality of the compressor 11 by a warning light, a sound, or the like.

The refrigeration cycle device 1 described above includes the air conditioning evaporator 16 for cooling the vehicle cabin as the space to be air conditioned, and the device evaporator 19 that absorbs heat from the heat generating device 63 and the like. According to this, it is easy to regulate the temperature of the space to be air conditioned and the heat generating device 63 to an appropriate temperature.

In particular, since the first decompression valve 15 regulates the degree of superheating of the refrigerant on the refrigerant outlet port side of the air conditioning evaporator 16, heat exchange between the refrigerant and the ventilation air in the air conditioning evaporator 16 can be performed with high efficiency.

In addition, since the second decompression valve 18 regulates the degree of superheating of the refrigerant on the refrigerant suction side of the compressor 11, the temperature of the refrigerant on the refrigerant discharge side of the compressor 11 can be suppressed, and deterioration of oil returnability can be suppressed.

Therefore, according to the refrigeration cycle device 1 of the present embodiment, it is possible to appropriately protect the compressor 11 and the heat generating device 63 while ensuring or improving the air conditioning performance of the space to be air conditioned.

The refrigeration cycle device 1 of the present embodiment has the following features.

(1) The refrigeration cycle device 1 includes the evaporation pressure regulating valve 17 that is disposed on the downstream side of the air conditioning evaporator 16 and regulates the evaporation pressure of the refrigerant in the air conditioning evaporator 16. The evaporation pressure regulating valve 17 is disposed on the downstream side of a detection point of the first physical quantity. Specifically, the evaporation pressure regulating valve 17 is disposed between the evaporator-side sensor 103 and the refrigerant joining portion 20.

According to this, by regulating the evaporation pressure of the refrigerant in the air conditioning evaporator 16 to a desired pressure by the evaporation pressure regulating valve 17, freezing of condensed water on the outer surface of the air conditioning evaporator 16 can be suppressed. Since the evaporation pressure regulating valve 17 is disposed on the downstream side of the evaporator-side sensor 103, the evaporation pressure regulating valve 17 does not affect the regulation of the degree of superheating of the refrigerant on the refrigerant outlet port side of the air conditioning evaporator 16 by the first decompression valve 15. Therefore, it is possible to ensure or improve the air conditioning performance for the space to be air conditioned.

(2) The evaporator-side sensor 103 is disposed immediately behind the refrigerant outlet port of the air conditioning evaporator 16. According to this, the evaporator-side sensor 103 can detect the first physical quantity correlated with the degree of superheating of the refrigerant immediately after flowing out of the air conditioning evaporator 16. As a result, the degree of superheating of the refrigerant on the refrigerant outlet port side of the air conditioning evaporator 16 can be appropriately regulated, and air conditioning performance for the space to be air conditioned can be ensured or improved.

### Second Embodiment

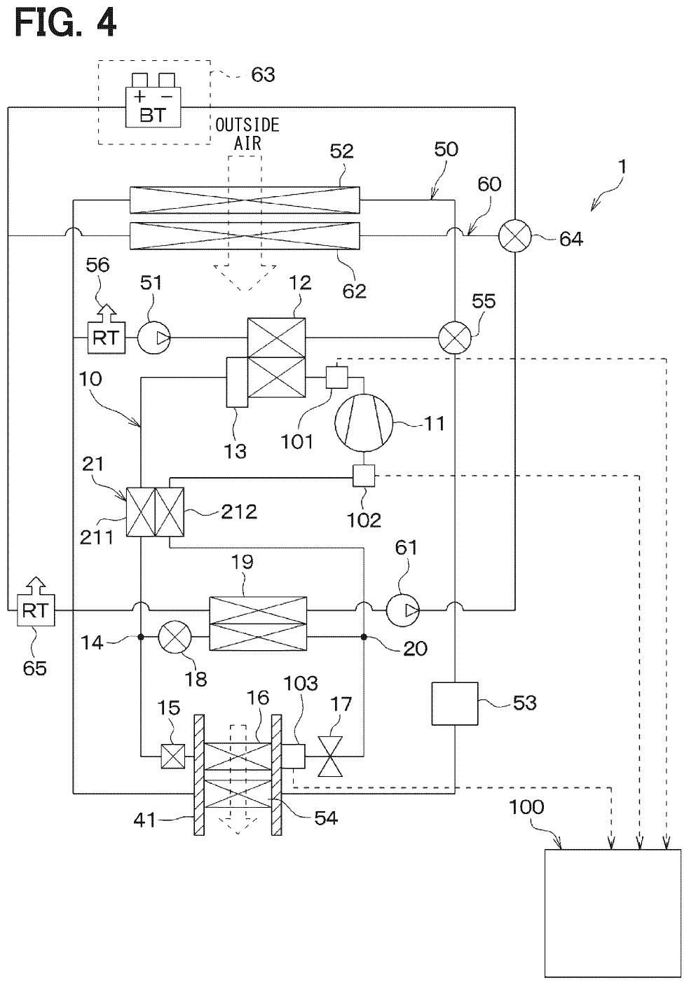

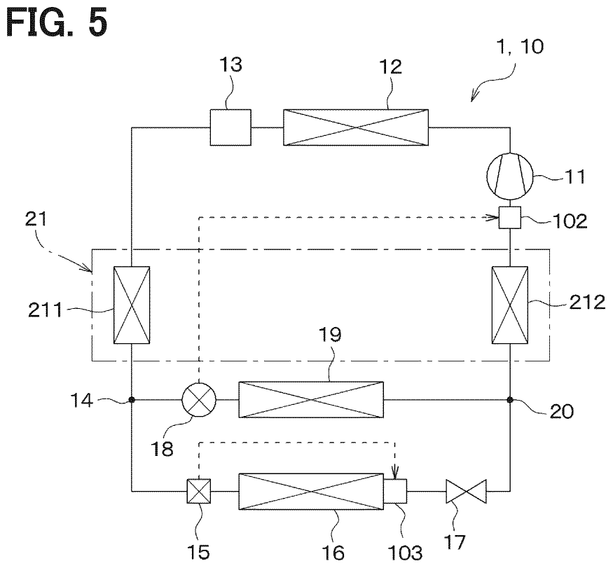

Next, a second embodiment will be described with reference to FIGS. 4 and 5. The present embodiment will mainly describe differences from the first embodiment.

As illustrated in FIGS. 4 and 5, the refrigeration cycle 10 includes an internal heat exchanger 21 that exchanges heat between a high-pressure refrigerant and a low-pressure refrigerant flowing in the cycle. The internal heat exchanger 21 includes a high-pressure flow path portion 211 through which the high-pressure refrigerant passes and a low-pressure flow path portion 212 through which the low-pressure refrigerant passes.

The high-pressure refrigerant flowing upstream of at least one of the first decompression valve 15 or the second decompression valve 18 passes through the high-pressure flow path portion 211. Specifically, the high-pressure flow path portion is disposed in a refrigerant path from the liquid receiving portion 13 to at least one of the first decompression valve 15 or the second decompression valve 18. The refrigerant path includes a path from the liquid receiving portion 13 to the refrigerant branch portion 14, a path from the refrigerant branch portion 14 to the first decompression valve 15, and a path from the refrigerant branch portion 14 to the second decompression valve 18.

The high-pressure flow path portion 211 of the present embodiment is disposed between the liquid receiving portion 13 and the refrigerant branch portion 14. For this reason, the refrigerant having passed through the high-pressure flow path portion 211 flows to both the first decompression valve 15 and the second decompression valve 18.

The low-pressure refrigerant flowing downstream of at least one of the air conditioning evaporator 16 or the device evaporator 19 passes through the low-pressure flow path portion 212. The low-pressure flow path portion 212 is disposed in a refrigerant path from one of the evaporator-side sensor 103 and the device evaporator 19 to the suction-side sensor 102. The refrigerant path includes a path from the evaporator-side sensor 103 to the refrigerant joining portion 20, a path from the device evaporator 19 to the refrigerant joining portion 20, and a path from the refrigerant joining portion 20 to the suction-side sensor 102.

The low-pressure flow path portion 212 of the present embodiment is disposed between the refrigerant joining portion 20 and the suction-side sensor 102. For this reason, the refrigerant having passed through the air conditioning evaporator 16 and the refrigerant having passed through the device evaporator 19 flow into the low-pressure flow path portion 212.

The evaporation pressure regulating valve 17 is disposed in the refrigerant path from the evaporator-side sensor 103 to the low-pressure flow path portion 212. The refrigerant path includes a path from the evaporator-side sensor 103 to the refrigerant joining portion 20 and a path from the refrigerant joining portion 20 to the low-pressure flow path portion 212. The evaporation pressure regulating valve 17 of the present embodiment is disposed between the evaporator-side sensor 103 and the refrigerant joining portion 20.

Other operations are similar to those in the first embodiment. The refrigeration cycle device 1 according to the present embodiment can obtain the effects similar to those of the first embodiment from the configuration common to or equivalent to the first embodiment.

The refrigeration cycle device 1 of the present embodiment has the following features.

(1) In the refrigeration cycle device 1, since the high-pressure flow path portion 211 of the internal heat exchanger 21 is disposed downstream of the liquid receiving portion 13, the high-pressure liquid-phase refrigerant having passed through the liquid receiving portion 13 can be subcooled in the internal heat exchanger 21. In the refrigeration cycle device 1, the high-pressure flow path portion 211 is disposed between the liquid receiving portion 13 and the refrigerant branch portion 14. According to this, the enthalpy of the refrigerant flowing into the first decompression valve 15 and the second decompression valve 18 is reduced, so that the heat absorbing capability of both the air conditioning evaporator 16 and the device evaporator 19 can be improved.

(2) In the refrigeration cycle device 1, the low-pressure flow path portion 212 is disposed between the refrigerant joining portion 20 and the suction-side sensor 102. Even when the internal heat exchanger 21 is added, the degree of superheating of the refrigerant on the refrigerant suction side of the compressor 11 can be appropriately regulated while the degree of superheating of the refrigerant on the refrigerant outlet port side of the air conditioning evaporator 16 is appropriately regulated.

In particular, in the refrigeration cycle device 1 of the present embodiment, the refrigerant passes through both the high-pressure flow path portion 211 and the low-pressure flow path portion 212 of the internal heat exchanger 21 not only in a case where the air in the vehicle cabin is cooled but also in a case where the air in the vehicle cabin is heated and the temperature regulation of the heat generating device 63 is performed. According to this, the enthalpy of the refrigerant flowing into the first decompression valve 15 and the second decompression valve 18 is reduced to improve the heat absorbing capability of the air conditioning evaporator 16 and the device evaporator 19. Since the entire amount of the refrigerant flowing through the refrigeration cycle 10 passes through the internal heat exchanger 21, the refrigerant can be sufficiently subcooled.

(3) The evaporation pressure regulating valve 17 is disposed between the evaporator-side sensor 103 and the refrigerant joining portion 20. According to this, even when the internal heat exchanger 21 is added, the evaporation pressure of the refrigerant in the air conditioning evaporator 16 is regulated to a desired pressure by the evaporation pressure regulating valve 17, and thus freezing of condensed water on the outer surface of the air conditioning evaporator 16 can be suppressed.

### First Modification of Second Embodiment

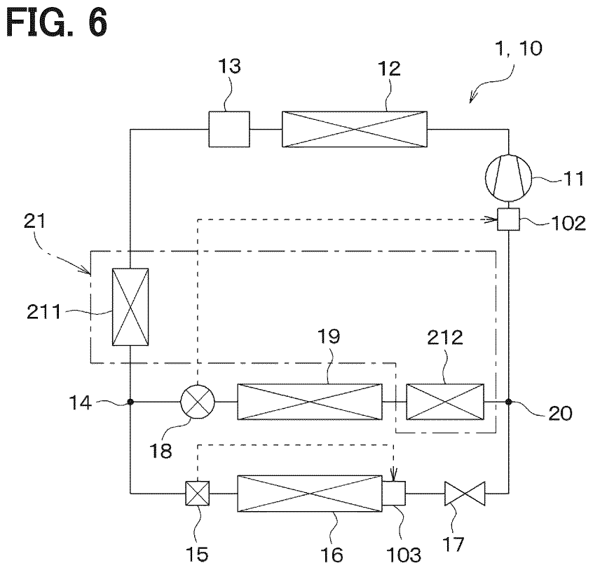

The example in which the low-pressure flow path portion 212 is disposed between the refrigerant joining portion 20 and the suction-side sensor 102 is described in the second embodiment. However, the arrangement of the low-pressure flow path portion 212 is not limited to this. For example, as illustrated in FIG. 6, the low-pressure flow path portion 212 may be disposed between the device evaporator 19 and the refrigerant joining portion 20. According to this, the low-pressure refrigerant flowing through the refrigeration cycle 10 flows through the internal heat exchanger 21 in the operation mode of heating the air in the vehicle cabin or cooling the heat generating device 63, so that the heat absorbing capability of the device evaporator 19 can be improved. On the other hand, in the operation mode of cooling or dehumidifying and heating the air in the vehicle cabin, the low-pressure refrigerant flowing through the refrigeration cycle 10 does not flow through the internal heat exchanger 21, and thus the pressure loss of the low-pressure refrigerant can be suppressed.

### Second Modification of Second Embodiment

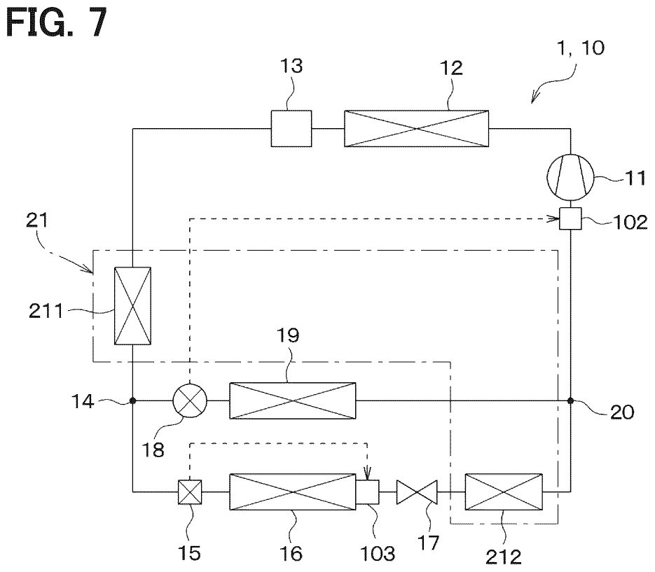

For example, as illustrated in FIG. 7, the low-pressure flow path portion 212 may be disposed between the evaporator-side sensor 103 and the refrigerant joining portion 20. In this case, the evaporation pressure regulating valve 17 is disposed between the evaporator-side sensor 103 and the low-pressure flow path portion 212. According to this, the low-pressure refrigerant flowing through the refrigeration cycle 10 flows through the internal heat exchanger 21 in the operation mode of cooling or dehumidifying and heating the air in the vehicle cabin, so that the heat absorbing capability of the air conditioning evaporator 16 can be improved. On the other hand, in the operation mode of heating the air in the vehicle cabin or cooling the heat generating device 63, the low-pressure refrigerant flowing through the refrigeration cycle 10 does not flow through the internal heat exchanger 21, and thus the pressure loss of the low-pressure refrigerant can be suppressed.

### Third Modification of Second Embodiment

The example in which the high-pressure flow path portion 211 is disposed between the liquid receiving portion 13 and the refrigerant branch portion 14 is described in the second embodiment. However, the arrangement of the high-pressure flow path portion 211 is not limited to this. The high-pressure flow path portion 211 may be disposed, for example, in the refrigerant path from the refrigerant branch portion 14 to the first decompression valve 15. In this case, the heat absorbing capability of the refrigerant in the air conditioning evaporator 16 can be improved. The high-pressure flow path portion 211 may be disposed, for example, in the refrigerant path from the refrigerant branch portion 14 to the second decompression valve 18. In this case, the heat absorbing capability of the refrigerant in the device evaporator 19 can be improved.

### Third Embodiment

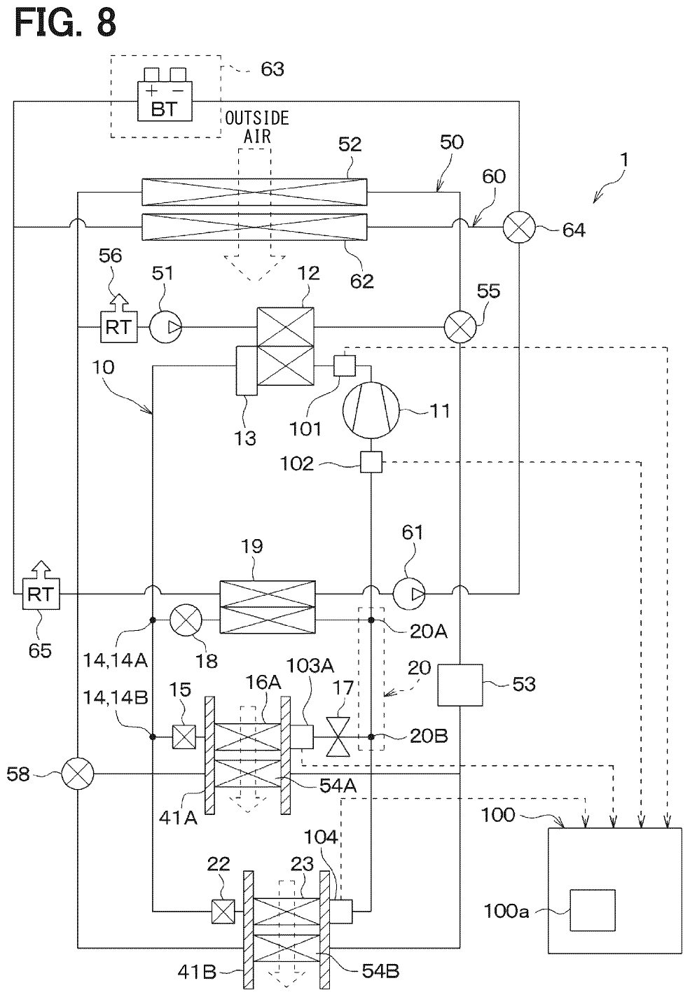

Next, a third embodiment will be described with reference to FIGS. 8 to 11. The present embodiment will mainly describe differences from the first embodiment.

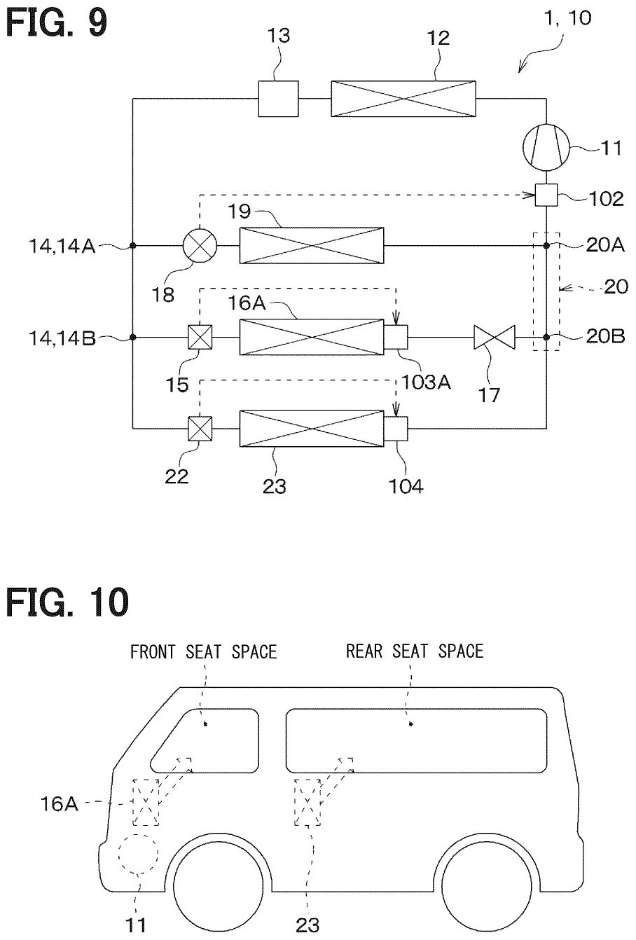

As illustrated in FIGS. 8 and 9, the refrigeration cycle device 1 includes a refrigerant branch portion 14 on the refrigerant outlet port side of the liquid receiving portion 13. The refrigerant branch portion 14 includes a first branch portion 14A and a second branch portion 14B.

The first branch portion 14A includes a three-way valve having one refrigerant inlet port and two refrigerant outlet ports. In the first branch portion 14A, a refrigerant outlet port of the liquid receiving portion 13 is connected to the refrigerant inlet port side. The second branch portion 14B is connected to one refrigerant outlet port side of the first branch portion 14A, and the second decompression valve 18 is connected to the other refrigerant outlet port side of the first branch portion.

The second branch portion 14B includes a three-way valve having one refrigerant inlet port and two refrigerant outlet ports. The first decompression valve 15 is connected to one refrigerant outlet port side of the second branch portion 14B, and a third decompression valve 22 is connected to the other refrigerant outlet port side of the second branch portion.

A first air conditioning evaporator 16A is connected to the refrigerant outlet port side of the first decompression valve 15. The first air conditioning evaporator 16A is disposed inside a casing 41A of a front air conditioning unit 40A together with a first heater core 54A. The first heater core 54A corresponds to the heater core 54 of the first embodiment. The first air conditioning evaporator 16A corresponds to the air conditioning evaporator 16 of the first embodiment.

The first air conditioning evaporator 16A exchanges heat between the refrigerant decompressed by the first decompression valve 15 and ventilation air to be supplied to the front seat space in the vehicle cabin to evaporate the refrigerant. In the first air conditioning evaporator 16A, the refrigerant absorbs heat from the ventilation air to be supplied to the front seat space in the vehicle cabin and evaporates to cool the air. The evaporation pressure regulating valve 17 is connected to the refrigerant outlet port side of the first air conditioning evaporator 16A.

The air having passed through the first air conditioning evaporator 16A passes through the first heater core 54A and is then supplied as conditioned air to the front seat space in the vehicle cabin. In the present embodiment, the first air conditioning evaporator 16A corresponds to “first evaporator”. In the present embodiment, the front seat space in the vehicle cabin corresponds to “space to be air conditioned”.

The third decompression valve 22 is connected in parallel with the first decompression valve 15 on the downstream side of the condenser 12. The third decompression valve 22 is a third decompression unit that decompresses the liquid-phase refrigerant that has passed through the condenser 12 and is stored in the liquid receiving portion 13. The third decompression valve 22 is an electric variable throttle whose operation is controlled by a control signal output from the control unit 100, and includes a valve body and an electric actuator. The third decompression valve 22 is configured as a variable throttle with the full-close function capable of substantially stopping the flow of the refrigerant.

A second air conditioning evaporator 23 is connected to the refrigerant outlet port side of the third decompression valve 22. The second air conditioning evaporator 23 is disposed inside a casing 41B of a rear air conditioning unit 40B together with a second heater core 54B. The second air conditioning evaporator 23 exchanges heat between the refrigerant decompressed by the third decompression valve 22 and ventilation air to be supplied to the rear seat space in the vehicle cabin to evaporate the refrigerant. In the second air conditioning evaporator 23, the refrigerant absorbs heat from the ventilation air to be supplied to the rear seat space in the vehicle cabin and evaporates to cool the air.

The air having passed through the second air conditioning evaporator 23 passes through the second heater core 54B and is then supplied as conditioned air to the rear seat space in the vehicle cabin. In the present embodiment, the second air conditioning evaporator 23 corresponds to “third evaporator”. In the present embodiment, the rear seat space in the vehicle cabin corresponds to “another space different from the space to be air conditioned”. Furthermore, in the present embodiment, the ventilation air to be supplied to the rear seat space in the vehicle cabin corresponds to “cooling medium”. The second air conditioning evaporator 23 may be configured to cool the same space as the space to which the air having passed through the first air conditioning evaporator 16 is supplied.

As illustrated in FIG. 10, in the vehicle, the first air conditioning evaporator 16A is disposed on the front side in the vehicle cabin, and the second air conditioning evaporator 23 is disposed on the rear side in the vehicle cabin. The second air conditioning evaporator 23 is disposed at a position farther from the compressor 11 than the first air conditioning evaporator 16A. As a result, the downstream side of the second air conditioning evaporator 23 is more susceptible to thermal damage than the downstream side of the first air conditioning evaporator 16A.

The second air conditioning evaporator 23 is disposed between the third decompression valve 22 and the refrigerant joining portion 20. The refrigerant joining portion 20 includes a first joining portion 20A and a second joining portion 20B. The second joining portion 20B is connected to the refrigerant outlet port side of the second air conditioning evaporator 23. The second joining portion 20B includes a three-way valve having two refrigerant inlet ports and one refrigerant outlet port. The second air conditioning evaporator 23 is connected to one refrigerant inlet port side of the second joining portion 20B, and the evaporation pressure regulating valve 17 is connected to the other refrigerant inlet port side of the second joining portion. The first joining portion 20A is connected to the refrigerant outlet port side of the second joining portion 20B.

The first joining portion 20A includes a three-way valve having two refrigerant inlet ports and one refrigerant outlet port. The second joining portion 20B is connected to one refrigerant inlet port side of the first joining portion 20A, and the device evaporator 19 is connected to the other refrigerant inlet port side. The refrigerant suction port of the compressor 11 is connected to the refrigerant outlet port side of the first joining portion 20A.

Here, the high-temperature side circuit 50 includes the first heater core 54A and the second heater core 54B instead of the heater core 54. The high-temperature side circuit 50 includes a third flow path switching valve 58.

The first heater core 54A and the second heater core 54B are connected in parallel downstream of the electric heater 53 in the high-temperature side circuit 50. The first heater core 54A is disposed inside the casing 41A of the front air conditioning unit 40A. The first heater core 54A exchanges heat between the high-temperature side heat medium heated by the condenser 12 and the ventilation air to be supplied to the front seat space in the vehicle cabin, thereby generating conditioned air with a desired temperature. The second heater core 54B is disposed inside the casing 41B of the rear air conditioning unit 40B. The second heater core 54B exchanges heat between the high-temperature side heat medium heated by the condenser 12 and the ventilation air to be supplied to the rear seat space in the vehicle cabin, thereby generating conditioned air with a desired temperature.

The third flow path switching valve 58 functions as a flow path switching unit that switches the flow path of the high-temperature side heat medium, similarly to the first flow path switching valve 55. The third flow path switching valve 58 is provided at a branch portion that branches the flow path of the high-temperature side heat medium into a flow path on the first heater core 54A side and a flow path on the second heater core 54B side in the high-temperature side circuit 50. The third flow path switching valve 58 includes an electromagnetic valve, and its operation is controlled by a control signal output from the control unit 100.

The control unit 100 includes a first evaporator-side sensor 103A provided on the refrigerant outlet port side of the first air conditioning evaporator 16A and a second evaporator-side sensor 104 provided on the refrigerant outlet port side of the second air conditioning evaporator 23. The first evaporator-side sensor 103A corresponds to the evaporator-side sensor 103 described in the first embodiment.

The second evaporator-side sensor 104 is a pressure temperature sensor that detects the pressure and temperature of the refrigerant having passed through the second air conditioning evaporator 23. In the second evaporator-side sensor 104, the pressure detection unit and the temperature detection unit may be integrally formed, or may be separately formed. The second evaporator-side sensor 104 is provided to detect the degree of superheating of the refrigerant having passed through the second air conditioning evaporator 23. The second evaporator-side sensor 104 is disposed in a refrigerant path from the second air conditioning evaporator 23 to the second joining portion 20B in the refrigeration cycle 10. In the present embodiment, the pressure and temperature of the refrigerant having passed through the second air conditioning evaporator 23 correspond to “third physical quantity” with a correlation with the degree of superheating of the refrigerant flowing between the second air conditioning evaporator 23 and the second joining portion 20B. In the present embodiment, the second evaporator-side sensor 104 corresponds to “third physical quantity detection unit”.

The second evaporator-side sensor 104 is disposed immediately behind the refrigerant outlet port of the second air conditioning evaporator 23 to minimize the influence of thermal damage. The location immediately behind the refrigerant outlet port of the second air conditioning evaporator 23 is a portion in which the state of the refrigerant is substantially the same as the state of the refrigerant at the refrigerant outlet port of the second air conditioning evaporator 23 on the downstream side of the second air conditioning evaporator 23. For example, the location immediately behind the refrigerant outlet port of the second air conditioning evaporator 23 can be interpreted as a portion located upstream of the intermediate point between the second air conditioning evaporator 23 and the second joining portion 20B in the refrigerant path from the second air conditioning evaporator 23 to the second joining portion 20B.

The control unit 100 operates the third decompression valve 22 in a manner that the degree of superheating of the refrigerant on the refrigerant outlet port side of the second air conditioning evaporator 23 approaches a third target degree of superheating on the basis of a sensor output of the second evaporator-side sensor 104. The third decompression valve 22 regulates the degree of superheating of the refrigerant between the second air conditioning evaporator 23 and the second joining portion 20B to the third target degree of superheating on the basis of the third physical quantity with a correlation with the degree of superheating of the refrigerant flowing between the second air conditioning evaporator 23 and the second joining portion 20B.

The control unit 100 is configured to be able to switch the heat absorbing mode in the refrigeration cycle 10 between a multi-endothermic mode and a single endothermic mode. The control unit 100 of the present embodiment includes a mode switching unit 100a that switches between the multi-endothermic mode and the single endothermic mode.

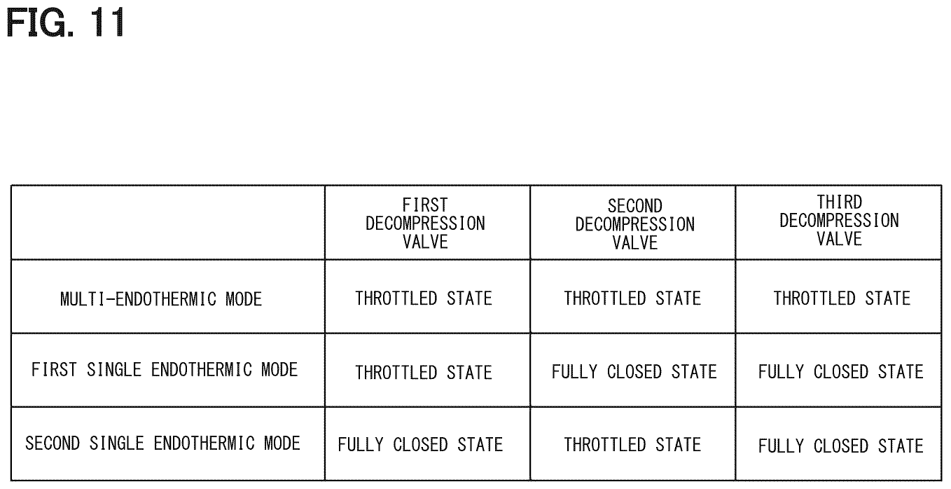

The multi-endothermic mode is, for example, a heat absorbing mode in which the first air conditioning evaporator 16A, the second air conditioning evaporator 23, and the device evaporator 19 each exert a refrigerant heat-absorbing action. For example, as illustrated in FIG. 11, the control unit 100 controls each of the first decompression valve 15, the second decompression valve 18, and the third decompression valve 22 to be in the throttled state in the multi-endothermic mode.

Specifically, the control unit 100 obtains the degree of superheating of the refrigerant between the first air conditioning evaporator 16A and the evaporation pressure regulating valve 17 on the basis of the sensor output of the first evaporator-side sensor 103A, and operates the first decompression valve 15 in a manner that the degree of superheating approaches the first target degree of superheating. In addition, the control unit 100 obtains the degree of superheating of the refrigerant between the first joining portion 20A and the compressor 11 on the basis of the sensor output of the suction-side sensor 102, and operates the second decompression valve 18 in a manner that the degree of superheating approaches the second target degree of superheating. Furthermore, the control unit 100 obtains the degree of superheating of the refrigerant between the second air conditioning evaporator 23 and the second joining portion 20B on the basis of the sensor output of the second evaporator-side sensor 104, and operates the third decompression valve 22 in a manner that the degree of superheating approaches the third target degree of superheating. As a result, each of the first air conditioning evaporator 16A, the second air conditioning evaporator 23, and the device evaporator 19 is in a state of exerting the refrigerant heat-absorbing action.

The single endothermic mode is, for example, a heat absorbing mode in which one of the first air conditioning evaporator 16A and the device evaporator 19 exerts the refrigerant heat-absorbing action. In this single endothermic mode, the other evaporator of the first air conditioning evaporator 16A and the device evaporator 19, and the second air conditioning evaporator 23 do not exert the refrigerant heat-absorbing action. The single endothermic mode includes a first single endothermic mode in which the first air conditioning evaporator 16A exerts the refrigerant heat-absorbing action and a second single endothermic mode in which the device evaporator 19 exerts the refrigerant heat-absorbing action. The single endothermic mode does not include a heat absorbing mode in which the second air conditioning evaporator 23 exerts the refrigerant heat-absorbing action.

The control unit 100 controls the first decompression valve 15 to be in the throttled state, and controls each of the second decompression valve 18 and the third decompression valve 22 to be in the fully closed state in the first single endothermic mode. Specifically, the control unit 100 obtains the degree of superheating of the refrigerant between the first air conditioning evaporator 16A and the evaporation pressure regulating valve 17 on the basis of the sensor output of the first evaporator-side sensor 103A, and operates the first decompression valve 15 in a manner that the degree of superheating approaches the first target degree of superheating. As a result, the first air conditioning evaporator 16A exerts the refrigerant heat-absorbing action.

In addition, the control unit 100 controls the second decompression valve 18 to be in the throttled state, and controls each of the first decompression valve 15 and the third decompression valve 22 to be in the fully closed state in the second single endothermic mode. Specifically, the control unit 100 obtains the degree of superheating of the refrigerant between the first joining portion 20A and the compressor 11 on the basis of the sensor output of the suction-side sensor 102, and operates the second decompression valve 18 in a manner that the degree of superheating approaches the second target degree of superheating. As a result, the device evaporator 19 exerts the refrigerant heat-absorbing action.

Here, in the present embodiment, the multi-endothermic mode and the single endothermic mode have been described as the heat absorbing modes, but it is not limited thereto. The heat absorbing mode may include, for example, a heat absorbing mode of causing the first air conditioning evaporator 16A and the device evaporator 19 among the first air conditioning evaporator 16A, the second air conditioning evaporator 23, and the device evaporator 19 to exert the refrigerant heat-absorbing action.

Other operations are similar to those in the first embodiment. The refrigeration cycle device 1 according to the present embodiment can obtain the effects similar to those of the first embodiment from the configuration common to or equivalent to the first embodiment.

The refrigeration cycle device 1 of the present embodiment has the following features.

(1) The refrigeration cycle device 1 includes the third decompression valve 22 disposed in parallel with the first decompression valve 15 on the downstream side of the condenser 12, and the second air conditioning evaporator 23 that exchanges heat between the refrigerant decompressed by the third decompression valve 22 and ventilation air to be supplied to the rear seat space in the vehicle cabin to evaporate the refrigerant. The second air conditioning evaporator 23 is disposed between the third decompression valve 22 and the refrigerant joining portion 20. The third decompression valve 22 regulates the degree of superheating of the refrigerant between the second air conditioning evaporator 23 and the refrigerant joining portion 20 to the third target degree of superheating on the basis of the third physical quantity with a correlation with the degree of superheating of the refrigerant between the second air conditioning evaporator 23 and the refrigerant joining portion 20.

As described above, by regulating the degree of superheating of the refrigerant on the refrigerant outlet port side of the second air conditioning evaporator 23 using the third decompression valve 22, heat exchange between the refrigerant in the second air conditioning evaporator 23 and the ventilation air to be supplied to the rear seat space in the vehicle cabin can be performed with high efficiency. Therefore, it is possible to ensure or improve the air conditioning performance of the rear seat space in the vehicle cabin, in addition to the front seat space in the vehicle cabin.

(2) The first evaporator-side sensor 103A as the first physical quantity detection unit is disposed immediately behind the refrigerant outlet port of the first air conditioning evaporator 16A. The second evaporator-side sensor 104 as the third physical quantity detection unit is disposed immediately behind the refrigerant outlet port of the second air conditioning evaporator 23.

According to this, the degree of superheating of the refrigerant on the refrigerant outlet port side of the first air conditioning evaporator 16A and the degree of superheating of the refrigerant on the refrigerant outlet port side of the second air conditioning evaporator 23 are appropriately regulated to ensure or improve the air conditioning performance of the rear seat space in the vehicle cabin, in addition to the front seat space in the vehicle cabin.

### First Modification of Third Embodiment

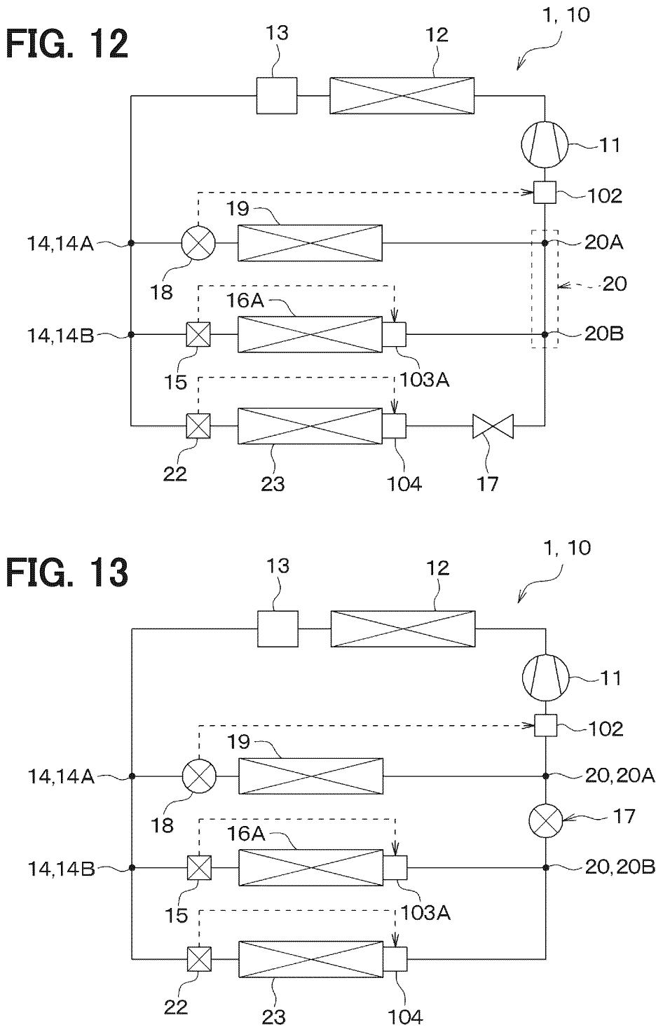

In the refrigeration cycle device 1 according to the third embodiment, the evaporation pressure regulating valve 17 is disposed between the first air conditioning evaporator 16A and the second joining portion 20B, but it is not limited thereto. For example, as illustrated in FIG. 12, in the refrigeration cycle device 1, the evaporation pressure regulating valve 17 may be disposed between the second air conditioning evaporator 23 and the second joining portion 20B. In this case, the evaporation pressure regulating valve 17 may be disposed between the second evaporator-side sensor 104 and the second joining portion 20B. In the refrigeration cycle device 1, the evaporation pressure regulating valve 17 may be disposed downstream of each of the first air conditioning evaporator 16A and the second air conditioning evaporator 23.

### Second Modification of Third Embodiment

For example, as illustrated in FIG. 13, in the refrigeration cycle device 1, the evaporation pressure regulating valve may be disposed between the second joining portion 20B located downstream of both the first air conditioning evaporator 16A and the second air conditioning evaporator 23, and the first joining portion 20A. According to this, by regulating the evaporation pressure of the refrigerant in both the first air conditioning evaporator 16A and the second air conditioning evaporator 23 to a desired pressure by the evaporation pressure regulating valve 17, freezing of condensed water on the outer surfaces of the air conditioning evaporators 16A and 23 can be suppressed.

### Fourth Embodiment

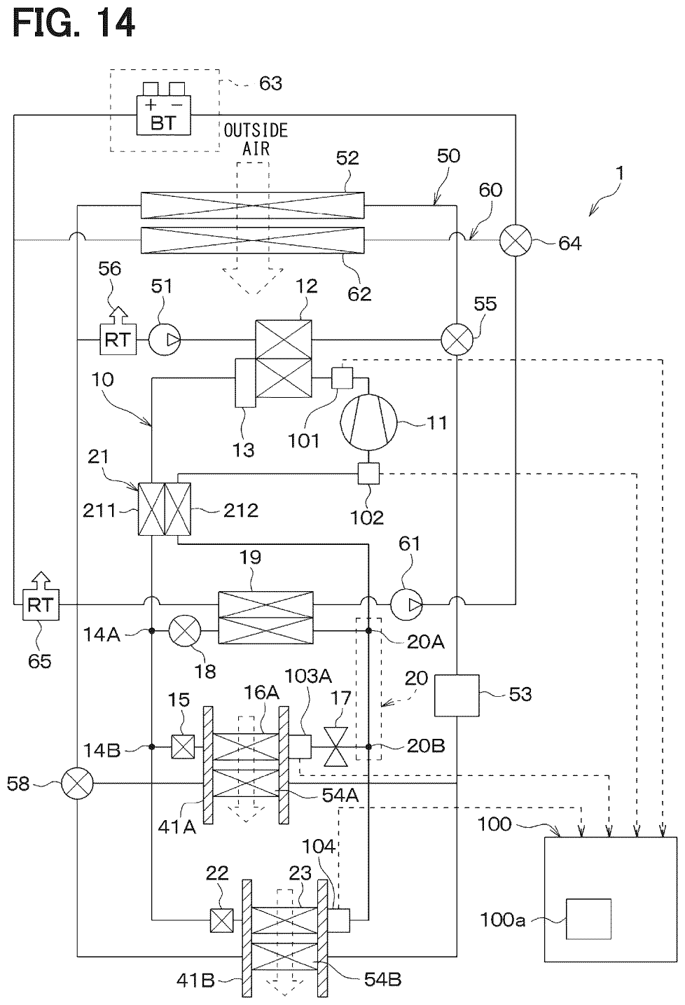

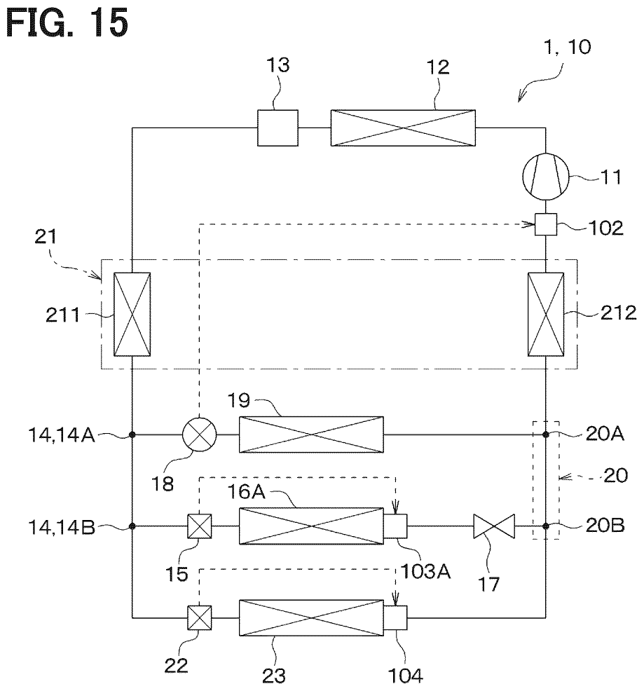

Next, a fourth embodiment will be described with reference to FIGS. 14 and 15. The present embodiment will mainly describe differences from the third embodiment.

As illustrated in FIGS. 14 and 15, the refrigeration cycle 10 includes the internal heat exchanger 21 that exchanges heat between a high-pressure refrigerant and a low-pressure refrigerant flowing in the cycle. The internal heat exchanger 21 includes the high-pressure flow path portion 211 through which the high-pressure refrigerant passes and the low-pressure flow path portion 212 through which the low-pressure refrigerant passes.

The high-pressure refrigerant flowing upstream of at least one of the first decompression valve 15, the second decompression valve 18, or the third decompression valve 22 passes through the high-pressure flow path portion 211. Specifically, the high-pressure flow path portion 211 is disposed in a refrigerant path from the liquid receiving portion 13 to at least one of the first decompression valve 15, the second decompression valve 18, or the third decompression valve 22. The refrigerant path includes a path from the liquid receiving portion 13 to each of the branch portions 14A and 14B, a path from the first branch portion 14A to the first decompression valve 15, a path from the second branch portion 14B to the second decompression valve 18, and a path from the second branch portion 14B to the third decompression valve 22.

The high-pressure flow path portion 211 of the present embodiment is disposed between the liquid receiving portion 13 and the first branch portion 14A. For this reason, the refrigerant having passed through the high-pressure flow path portion 211 flows to each of the first decompression valve 15, the second decompression valve 18, and the third decompression valve 22.

The low-pressure refrigerant flowing downstream of at least one of the first air conditioning evaporator 16A, the device evaporator 19, or the second air conditioning evaporator 23 passes through the low-pressure flow path portion 212. The low-pressure flow path portion 212 is disposed in a refrigerant path from one of the first evaporator-side sensor 103A, the second evaporator-side sensor 104, and the device evaporator 19 to the suction-side sensor 102. The refrigerant path includes a path from each of the evaporator-side sensors 103A and 104 to the first joining portion 20A, a path from the device evaporator 19 to the first joining portion 20A, and a path from the first joining portion 20A to the suction-side sensor 102.

The second air conditioning evaporator 23 is disposed away from the compressor 11. As a result, the degree of superheating on the refrigerant outlet port side of the second air conditioning evaporator 23 tends to increase due to the influence of thermal damage. If the low-pressure flow path portion 212 is disposed between the second air conditioning evaporator 23 and the second joining portion 20B, the degree of superheating of the refrigerant sucked into the compressor 11 is excessive. The excessive degree of superheating on the refrigerant outlet port side of the second air conditioning evaporator 23 is not preferable because the temperature of the compressor 11 tends to increase.

For this reason, the low-pressure flow path portion 212 is desirably disposed so as to avoid the refrigerant path from the second air conditioning evaporator 23 to the second joining portion 20B. That is, the low-pressure flow path portion 212 is desirably disposed in the refrigerant path from the first evaporator-side sensor 103A as the first physical quantity detection unit to the suction-side sensor 102 as the second physical quantity detection unit, or in the refrigerant path from the device evaporator 19 to the suction-side sensor 102.

In consideration of these, the low-pressure flow path portion 212 of the present embodiment is disposed between the refrigerant joining portion 20 and the suction-side sensor 102. Therefore, the refrigerant having passed through the first air conditioning evaporator 16A, the refrigerant having passed through the device evaporator 19, and the refrigerant having passed through the second air conditioning evaporator 23 flow into the low-pressure flow path portion 212.

The evaporation pressure regulating valve 17 is disposed in a refrigerant path from at least one of the first evaporator-side sensor 103A or the second evaporator-side sensor 104 to the low-pressure flow path portion 212. The refrigerant path includes a path from the first evaporator-side sensor 103A to the refrigerant joining portion 20, a path from the second evaporator-side sensor 104 to the refrigerant joining portion 20, and a path from the refrigerant joining portion 20 to the low-pressure flow path portion 212. The evaporation pressure regulating valve 17 of the present embodiment is disposed between the first evaporator-side sensor 103A and the second joining portion 20B.

Other operations are similar to those in the third embodiment. The refrigeration cycle device 1 according to the present embodiment can obtain the effects similar to those of the first embodiment from the configuration common to or equivalent to the first embodiment.

Furthermore, according to the present embodiment, the following effects can be obtained.

(1) In the refrigeration cycle device 1, the high-pressure flow path portion 211 is disposed between the liquid receiving portion 13 and the first branch portion 14A. According to this, the enthalpy of the refrigerant flowing into the first decompression valve 15, the second decompression valve 18, and the third decompression valve 22 decreases, so that the heat absorbing capability of the first air conditioning evaporator 16A, the device evaporator 19, and the second air conditioning evaporator 23 can be improved.

(2) In the refrigeration cycle device 1, the low-pressure flow path portion 212 is disposed between the refrigerant joining portion 20 and the suction-side sensor 102. Even when the internal heat exchanger 21 is added, the degree of superheating of the refrigerant on the refrigerant suction side of the compressor 11 can be appropriately regulated while the degree of superheating of the refrigerant on the refrigerant outlet port side of each of the air conditioning evaporators 16A and 23 is appropriately regulated.

In particular, in the refrigeration cycle device 1 of the present embodiment, the refrigerant passes through both the high-pressure flow path portion 211 and the low-pressure flow path portion 212 of the internal heat exchanger 21 not only in the multi-endothermic mode but also in the single endothermic mode. According to this, the heat absorbing capability of the first air conditioning evaporator 16A, the device evaporator 19, and the second air conditioning evaporator 23 can be improved.

(3) In the refrigeration cycle device 1, the low-pressure flow path portion 212 is disposed so as to avoid the refrigerant path from the second air conditioning evaporator 23 to the second joining portion 20B. That is, the low-pressure flow path portion 212 is disposed in the refrigerant path from the first evaporator-side sensor 103A as the first physical quantity detection unit to the suction-side sensor 102 as the second physical quantity detection unit, or in the refrigerant path from the device evaporator 19 to the suction-side sensor 102. Therefore, the degree of superheating on the refrigerant outlet port side of the second air conditioning evaporator 23 can be suppressed from becoming excessive. As a result, it is possible to ensure the comfortableness of the rear seat space in the vehicle cabin.

(4) The evaporation pressure regulating valve 17 is disposed between the first evaporator-side sensor 103A and the refrigerant joining portion 20. According to this, even when the internal heat exchanger 21 is added, the evaporation pressure of the refrigerant in the first air conditioning evaporator 16A is regulated to a desired pressure by the evaporation pressure regulating valve 17, and thus freezing of condensed water on the outer surface of the first air conditioning evaporator 16A can be suppressed.

### First Modification of Fourth Embodiment

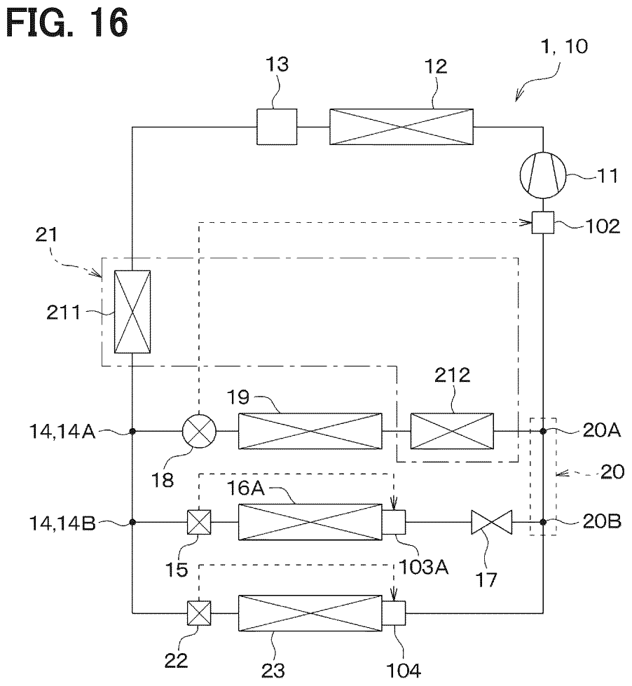

In the refrigeration cycle device 1 of the fourth embodiment, the low-pressure flow path portion 212 is disposed between the refrigerant joining portion 20 and the suction-side sensor 102 by way of example, but it is not limited to thereto. In the refrigeration cycle device 1, for example, as illustrated in FIG. 16, the low-pressure flow path portion 212 may be disposed between the device evaporator 19 and the refrigerant joining portion 20. In this case, the heat absorbing capability of the device evaporator 19 can be improved.

### Second Modification of Fourth Embodiment

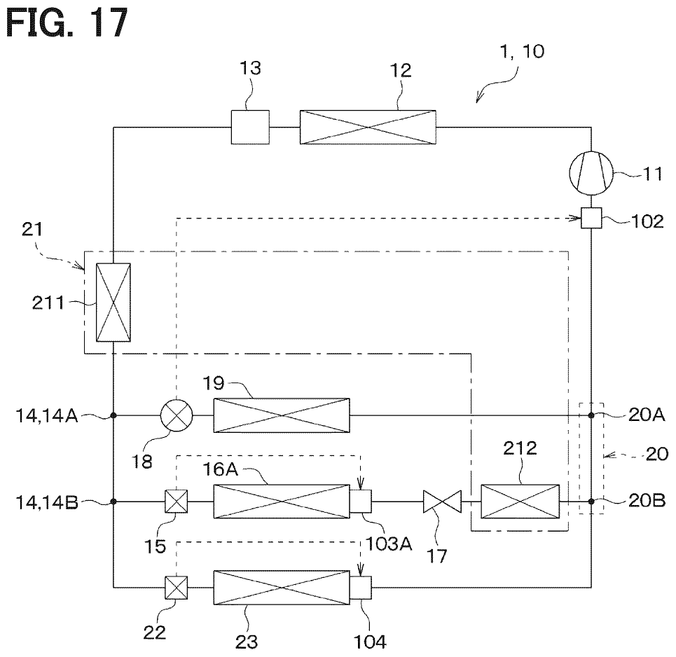

In the refrigeration cycle device 1, for example, as illustrated in FIG. 17, the low-pressure flow path portion 212 may be disposed between the first evaporator-side sensor 103A and the refrigerant joining portion 20. In this case, the heat absorbing capability of the first air conditioning evaporator 16A can be improved. The evaporation pressure regulating valve 17 is disposed between the first evaporator-side sensor 103A and the low-pressure flow path portion 212.

### Third Modification of Fourth Embodiment

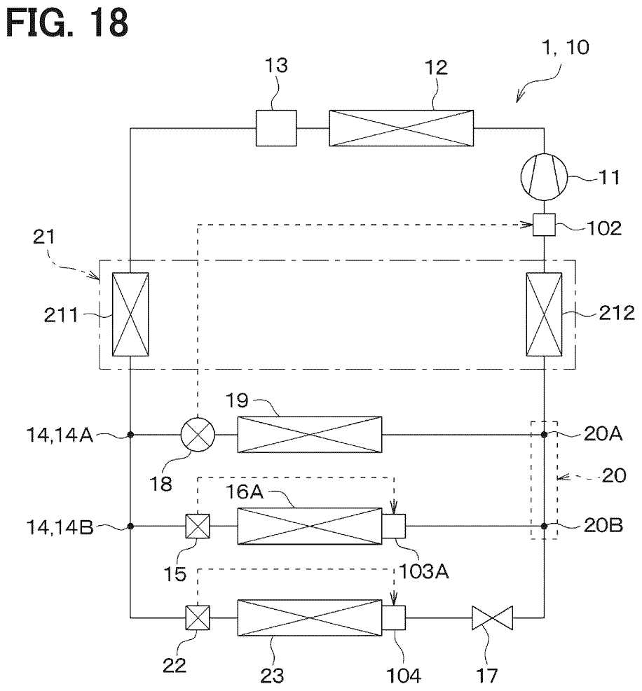

In the refrigeration cycle device 1 of the fourth embodiment, the evaporation pressure regulating valve 17 is disposed between the first evaporator-side sensor 103A and the second joining portion 20B, but it is not limited thereto. For example, as illustrated in FIG. 18, in the refrigeration cycle device 1, the evaporation pressure regulating valve 17 may be disposed between the second evaporator-side sensor 104 and the second joining portion 20B. According to this, by regulating the evaporation pressure of the refrigerant in the second air conditioning evaporator 23 to a desired pressure by the evaporation pressure regulating valve 17, freezing of condensed water on the outer surface of the second air conditioning evaporator 23 can be suppressed.

### Fourth Modification of Fourth Embodiment

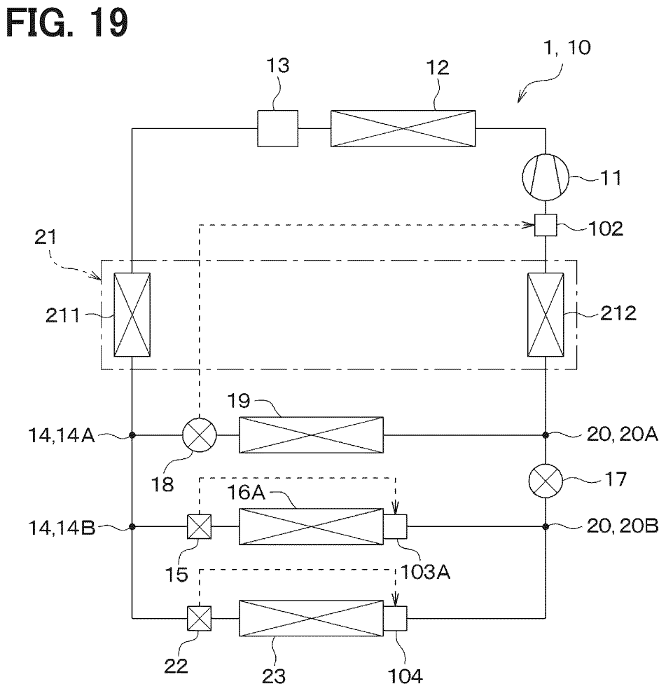

For example, as illustrated in FIG. 19, in the refrigeration cycle device 1, the evaporation pressure regulating valve 17 may be disposed downstream of each of the first evaporator-side sensor 103A and the second evaporator-side sensor 104. In this case, by regulating the evaporation pressure of the refrigerant in both the first air conditioning evaporator 16A and the second air conditioning evaporator 23 to a desired pressure by the evaporation pressure regulating valve 17, freezing of condensed water on the outer surfaces of the air conditioning evaporators 16A and 23 can be suppressed.

### Fifth Modification of Fourth Embodiment

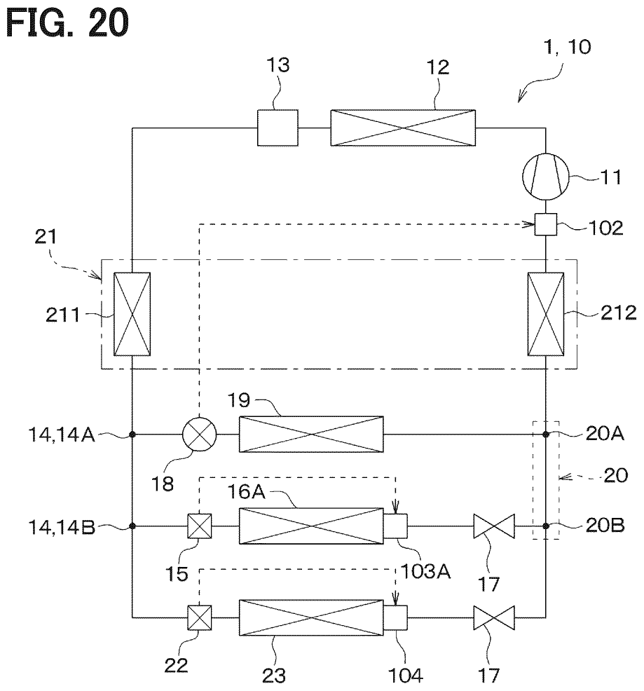

For example, as illustrated in FIG. 20, in the refrigeration cycle device 1, the evaporation pressure regulating valve may be disposed between the second joining portion 20B located downstream of both the first air conditioning evaporator 16A and the second air conditioning evaporator 23, and the first joining portion 20A. In this case, by regulating the evaporation pressure of the refrigerant in both the first air conditioning evaporator 16A and the second air conditioning evaporator 23 to a desired pressure by the evaporation pressure regulating valve 17, freezing of condensed water on the outer surfaces of the air conditioning evaporators 16A and 23 can be suppressed.

### OTHER EMBODIMENTS

Although the representative embodiments of the present disclosure have been described above, the present disclosure is not limited to the above embodiments, and various modifications can be made as follows.

In the above embodiments, the refrigeration cycle 10 is described with a specific configuration, but the refrigeration cycle 10 may have a configuration different from that described above. The refrigeration cycle 10 of the above embodiments includes the liquid receiving portion 13 and the evaporation pressure regulating valve 17, but these are not essential and may be omitted.

As in the embodiments described above, the evaporator-side sensor 103 is desirably disposed immediately behind the refrigerant outlet port of the air conditioning evaporator 16, but it is not limited thereto, and the evaporator-side sensor may be disposed at a position away from the refrigerant outlet port of the air conditioning evaporator 16 to some extent. The same applies to the first evaporator-side sensor 103A and the second evaporator-side sensor 104.

The refrigeration cycle device 1 of each of the third and fourth embodiments described above is configured to cool the rear seat space in the vehicle cabin by the second air conditioning evaporator 23, but it is not limited thereto. For example, the refrigeration cycle device may be configured to cool the inside of a refrigerator, a freezer, or the like.

In the above embodiments, the high-temperature side circuit 50 is described with a specific configuration, but the high-temperature side circuit 50 may have a configuration different from that described above. For example, heat of the high-temperature side heat medium may be used for heating the heat generating device 63.

In the above embodiments, the low-temperature side circuit 60 is described with a specific configuration, but the low-temperature side circuit 60 may have a configuration different from that described above.

Each of the decompression valves 15, 18, and 22 of the above embodiments includes an electric variable throttle, but it is not limited thereto. Each of the decompression valves 15, 18, and 22 may include, for example, a mechanical expansion valve including a temperature sensing unit for detecting the degree of superheating of the refrigerant. In this case, the temperature sensing units of the decompression valves 15, 18, and 22 correspond to the physical quantity detection units.

The refrigeration cycle 10 of the above embodiments is configured as a receiver cycle in which the liquid receiving portion 13 is provided downstream of the condenser 12, but it is not limited thereto. The refrigeration cycle 10 may have a cycle configuration without the liquid receiving portion 13.

In the above embodiments, the refrigeration cycle device 1 is applied to a vehicle air conditioner. However, the refrigeration cycle device 1 is not limited to a mobile-object air conditioner, and can be applied to, for example, a stationary air conditioner or a portable air conditioner.

In the above embodiments, it is understood that the elements constituting the embodiments are not necessarily essential except for a case where it is explicitly stated that the elements are particularly essential and a case where the elements are considered to be obviously essential in principle.

In the above embodiments, when a numerical value such as the number, numerical value, amount, range, or the like of the constituent elements of the embodiment is mentioned, the numerical value is not limited to a specific number unless otherwise specified as essential or obviously limited to the specific number in principle.

In the above embodiments, when the shape, positional relationship, and the like of the constituent elements and the like are referred to, the shape, the positional relationship, and the like are not limited unless otherwise specified or limited to specific shapes, positional relationships, and the like in principle.

The control unit and the method of the present disclosure may be implemented by a dedicated computer provided by configuring a processor and a memory programmed to execute one or a plurality of functions embodied by a computer program. The control unit and the method of the present disclosure may be implemented by a dedicated computer provided by configuring a processor with one or more dedicated hardware logic circuits. The control unit and the method of the present disclosure may be implemented by one or more dedicated computers configured by a combination of a processor and a memory programmed to perform one or a plurality of functions and a processor configured with one or more hardware logic circuits. The computer program may be stored in a computer-readable non-transition tangible recording medium as an instruction performed by a computer.

What is claimed is:

1. A refrigeration cycle device comprising:
a compressor configured to compress and discharge a refrigerant;
a radiator configured to radiate heat of the refrigerant discharged from the compressor;
a first decompression unit configured to decompress the refrigerant having passed through the radiator;
a first evaporator that exchanges heat between the refrigerant decompressed by the first decompression unit and ventilation air to be supplied to a space to be air conditioned, to evaporate the refrigerant;
a second decompression unit that is disposed in parallel with the first decompression unit on a downstream side of the radiator to decompress the refrigerant having passed through the radiator;
a second evaporator that exchanges heat between the refrigerant decompressed by the second decompression unit and a heat medium that absorbs heat from at least one of a heat generating device or an external space, and evaporates the refrigerant; and
a refrigerant joining portion provided on a refrigerant suction side of the compressor, to join the refrigerant having passed through the first evaporator and the refrigerant having passed through the second evaporator, wherein
the first decompression unit is configured to regulate a degree of superheating of the refrigerant between the first evaporator and the refrigerant joining portion to a first target degree of superheating based on a first physical quantity having a correlation with the degree of superheating of the refrigerant flowing between the first evaporator and the refrigerant joining portion, and
the second decompression unit is configured to regulate a degree of superheating of the refrigerant between the refrigerant joining portion and the compressor to a second target degree of superheating based on a second physical quantity having a correlation with the degree of superheating of the refrigerant flowing between the refrigerant joining portion and the compressor.

2. The refrigeration cycle device according to claim 1, further comprising
an internal heat exchanger that includes a high-pressure flow path portion through which the refrigerant flowing upstream of at least one of the first decompression unit or the second decompression unit passes, and a low-pressure flow path portion through which the refrigerant flowing downstream of at least one of the first evaporator or the second evaporator passes, and exchanges heat between the refrigerant passing through the high-pressure flow path portion and the refrigerant passing through the low-pressure flow path portion;
a first physical quantity detection unit disposed between the first evaporator and the refrigerant joining portion to detect the first physical quantity; and
a second physical quantity detection unit disposed between the refrigerant joining portion and the compressor to detect the second physical quantity, wherein
the low-pressure flow path portion is arranged in a refrigerant path from one of the first physical quantity detection unit or the second evaporator to the second physical quantity detection unit.

3. The refrigeration cycle device according to claim 2, wherein the low-pressure flow path portion is arranged in a refrigerant path from the first physical quantity detection unit to the second physical quantity detection unit.

4. The refrigeration cycle device according to claim 2, wherein the first physical quantity detection unit is arranged immediately behind a refrigerant outlet port of the first evaporator.

5. The refrigeration cycle device according to claim 1, further comprising
a pressure regulating unit disposed on a downstream side of the first evaporator to regulates an evaporation pressure of the refrigerant in the first evaporator,
wherein the pressure regulating unit is disposed on a downstream side of a detection point of the first physical quantity.

6. The refrigeration cycle device according to claim 3, further comprising
a pressure regulating unit disposed on a downstream side of the first evaporator to regulate an evaporation pressure of the refrigerant in the first evaporator, wherein
the low-pressure flow path portion is provided on the downstream side of the first evaporator, and
the pressure regulating unit is disposed in a refrigerant path from the first physical quantity detection unit to the low-pressure flow path portion.

7. The refrigeration cycle device according to claim 1, further comprising:
a third decompression unit disposed in parallel with the first decompression unit on a downstream side of the radiator, to decompress the refrigerant having passed through the radiator; and
a third evaporator that exchanges heat between the refrigerant decompressed by the third decompression unit and a cooling medium that cools an another space different from the space to be air conditioned, and evaporates the refrigerant, wherein
the third evaporator is arranged between the third decompression unit and the refrigerant joining portion, and
the third decompression unit regulates a degree of superheating of the refrigerant between the third evaporator and the refrigerant joining portion to approach a third target degree of superheating based on a third physical quantity having a correlation with the degree of superheating of the refrigerant between the third evaporator and the refrigerant joining portion.

8. The refrigeration cycle device according to claim 7, further comprising
an internal heat exchanger that includes a high-pressure flow path portion through which the refrigerant flowing from upstream of at least one of the first decompression unit, the second decompression unit, or the third decompression unit passes, and a low-pressure flow path portion through which the refrigerant flowing downstream of at least one of the first evaporator, the second evaporator, or the third evaporator passes, and exchanges heat between the refrigerant passing through the high-pressure flow path portion and the refrigerant passing through the low-pressure flow path portion;
a first physical quantity detection unit disposed between the first evaporator and the refrigerant joining portion to detect the first physical quantity;
a second physical quantity detection unit disposed between the refrigerant joining portion and the compressor to detect the second physical quantity; and
a third physical quantity detection unit disposed between the third evaporator and the refrigerant joining portion to detect the third physical quantity, wherein
the low-pressure flow path portion is disposed in a refrigerant path from one of the first physical quantity detection unit, the second evaporator or the third physical quantity detection unit to the second physical quantity detection unit.

9. The refrigeration cycle device according to claim 8, wherein
the first physical quantity detection unit is disposed immediately behind a refrigerant outlet port of the first evaporator, and
the third physical quantity detection unit is disposed immediately behind a refrigerant outlet port of the third evaporator.

10. The refrigeration cycle device according to claim 8, wherein the third evaporator is disposed at a position farther from the compressor than the first evaporator, the refrigeration cycle device further comprising
a mode switching unit configured to switch to a single endothermic mode in which (i) one evaporator of the first evaporator or the second evaporator exerts a refrigerant heat-absorbing action, and (ii) an another evaporator other than the one evaporator among the first evaporator, the second evaporator and the third evaporator does not exert the refrigerant heat-absorbing action, and
wherein the low-pressure flow path portion is disposed in a refrigerant path from the first physical quantity detection unit to the second physical quantity detection unit or in a refrigerant path from the second evaporator to the second physical quantity detection unit.

11. The refrigeration cycle device according to claim 8, further comprising
a pressure regulating unit that is disposed on a downstream side of at least one of the first evaporator or the third evaporator and regulates an evaporation pressure of the refrigerant in at least one of the first evaporator or the third evaporator,
wherein the pressure regulating unit is disposed on a downstream side of at least one of the first physical quantity detection unit or the third physical quantity detection unit.

12. The refrigeration cycle device according to claim 11, wherein the pressure regulating unit is disposed in a refrigerant path from at least one of the first physical quantity detection unit or the third physical quantity detection unit to the low-pressure flow path portion.

13. A refrigeration cycle device comprising:
a compressor configured to compress and discharge a refrigerant;
a radiator configured to radiate heat of the refrigerant discharged from the compressor;
a first decompression valve configured to decompress the refrigerant having passed through the radiator;
a first evaporator that exchanges heat between the refrigerant decompressed by the first decompression unit and air to be supplied to a space to be air conditioned, to evaporate the refrigerant;
a second decompression valve that is disposed in parallel with the first decompression valve on a downstream side of the radiator to decompress the refrigerant having passed through the radiator;
a second evaporator that exchanges heat between the refrigerant decompressed by the second decompression unit and a heat medium that absorbs heat from a heat generating device, and evaporates the refrigerant;
a refrigerant joint provided on a refrigerant suction side of the compressor, to join the refrigerant having passed through the first evaporator and the refrigerant having passed through the second evaporator;
a first physical quantity detector disposed between the first evaporator and the refrigerant joint to detect a first physical quantity having a correlation with a degree of superheating of the refrigerant flowing between the first evaporator and the refrigerant joint; and
a second physical quantity detector disposed between the refrigerant joint and the compressor to detect a second physical quantity having a correlation with the degree of superheating of the refrigerant flowing between the refrigerant joint and the compressor, wherein
the first decompression valve is configured to regulate the degree of superheating of the refrigerant between the first evaporator and the refrigerant joint to a first target degree based on the first physical quantity, and
the second decompression valve is configured to regulate the degree of superheating of the refrigerant between the refrigerant joint and the compressor to a second target degree based on the second physical quantity.
